(19) United States
(12) Patent Application Publication
(10) Pub. No.: US 2022/0416666 A1
(43) Pub. Date: Dec. 29, 2022

(54) CONTROL CIRCUIT FOR DC/DC CONVERTER

(71) Applicant: ROHM CO., LTD., Kyoto-shi (JP)

(72) Inventors: Akihiro KAWANO, Kyoto-shi (JP); Hiroaki ANDO, Kyoto-shi (JP)

(21) Appl. No.: 17/895,394

(22) Filed: Aug. 25, 2022

Related U.S. Application Data
(63) Continuation of application No. PCT/JP2020/048465, filed on Dec. 24, 2020.

(30) Foreign Application Priority Data
Feb. 25, 2020 (JP) 2020-029410
Feb. 28, 2020 (JP) 2020-034055
Mar. 5, 2020 (JP) 2020-038135

(51) Int. Cl. H02M 3/158; H02M 1/00; H02M 1/14

(52) U.S. Cl. CPC H02M 3/1588; H02M 1/0032; H02M 1/0009; H02M 1/14

(57) ABSTRACT

A first comparator is enabled during a period in which a wake-up signal is asserted and asserts a first detection signal indicative of a comparison result between a first feedback voltage generated by a first voltage dividing circuit and a first threshold voltage. A second comparator is always enabled and asserts a second detection signal indicative of a comparison result between a second feedback voltage V_{FB} generated by a second voltage dividing circuit and a second threshold voltage V_{TH}. A logic circuit generates a first pulse signal based on a first detection signal or a second detection signal, asserts the wake-up signal in a non-light load state, and negates the wake-up signal in a light load state.

### CROSS REFERENCE TO RELATED APPLICATIONS

This application is a continuation under 35 U.S.C. § 120 of PCT/JP2020/048465, filed Dec. 24, 2020, which is incorporated herein by reference, and which claimed priority to Japanese Application No. 2020-029410, filed Feb. 25, 2020; Japanese Application No. 2020-034055, filed Feb. 28, 2020; and Japanese Application No. 2020-038135, filed Mar. 5, 2020. The present application likewise claims priority under 35 U.S.C. § 119 to Japanese Application No. 2020-029410, filed Feb. 25, 2020; Japanese Application No. 2020-034055, filed Feb. 28, 2020; and, Japanese Application No. 2020-038135, filed Mar. 5, 2020. The entire contents of all of the three priority applications are also incorporated herein by reference.

### BACKGROUND

### 1. Technical Field

The present disclosure relates to a DC/DC converter.

### 2. Description of the Related Art

A DC/DC converter is used when a DC (direct current) voltage of a certain voltage value is converted into a DC voltage of another voltage value. As a control method of the DC/DC converter, a ripple control method is known. The ripple control method is a method in which an output voltage of the DC/DC converter is compared with a threshold voltage, and when the output voltage exceeds (or falls below) the threshold voltage, the switching transistor is switched on and off with the output voltage as a trigger. The ripple control method has an advantage that a response speed is high and power consumption can be reduced as compared with a voltage mode control method or an electric current mode control method using an error amplifier.

In an Internet of Things (IoT) device, an electronic circuit inside the device is required to reduce power consumption to the utmost, and a DC/DC converter is no exception. FIG. 1 is a circuit diagram of a DC/DC converter 100R studied by the present inventors. The DC/DC converter 100R is a boost converter that boosts an input voltage V_{IN} from a battery and supplies an output voltage V_{OUT} stabilized to a predetermined target level to a load 4.

The DC/DC converter 100R includes an output circuit 110 and a control circuit 200R using ripple control method. The output voltage V_{OUT} of the DC/DC converter 100R is fed back to the control circuit 200R and divided by a resistance voltage dividing circuit 202. The divided output voltage (feedback voltage) V_{OUT}′ is input to a main comparator 204.

The main comparator 204 is enabled in a non-light load state and compares the feedback voltage V_{OUT}′ with a threshold voltage V_{TH}. For example, in the case of a bottom detection method, the threshold voltage V_{TH} defines a bottom level of the output voltage V_{OUT}. A logic circuit 206 receives an output of the main comparator 204 and causes a pulse signal S1 to transition to an ON level when the feedback voltage V_{OUT}′ falls below the threshold voltage V_{TH}. Then, after a certain appropriate ON time has elapsed, the pulse signal S1 is caused to transition to an OFF level. A driver 208 drives a switching transistor M1 in accordance with the pulse signal S1. Furthermore, the logic circuit 206 generates a pulse signal S2 complementary to the pulse signal S1. A driver 210 drives a synchronous rectification transistor M2 according to the pulse signal S2.

When a response delay of the main comparator 204 is large, a degree in which the output voltage V_{OUT} falls below a target voltage becomes large. Therefore, the main comparator 204 is required to have a high-speed responsiveness, and thus its power consumption rises.

In a light load state, since a decreasing speed of the output voltage V_{OUT} is slow, the response speed required for the comparator may be slow. Therefore, separately from the main comparator 204, a sub-comparator 212 having a low response speed but low power consumption is provided. In the light load state, the main comparator 204 is turned off, and the sub-comparator 212 detects that the output voltage V_{OUT} falls below the threshold voltage. Accordingly, it is not necessary to operate the main comparator 204 at all times, so that the power consumption of the control circuit 200R can be greatly reduced.

As a result of studying the control circuit 200R in FIG. 1, the present inventors have recognized the following problems. Furthermore, this problem should not be understood as a general recognition of those skilled in the art.

As described above, the main comparator 204 is disabled and enabled in the light load state and the non-light load state. When enabling/disabling of the main comparator 204 is switched, a noise 120 is generated at an input terminal thereof. Since the input of the main comparator 204 and the input of the sub-comparator 212 are both connected, the noise 120 generated in the main comparator 204 affects the input of the sub-comparator 212. When the sub-comparator 212 is affected by the noise 120, its output changes, and the switching transistor M1 and the synchronous rectification transistor M2 malfunction.

In order to reduce a leakage current from the output of the DC/DC converter 100R, a resistance value of the voltage dividing circuit 202 is designed to be sufficiently large (for example, tens of MΩ to hundreds of MΩ). Therefore, the main comparator 204 and the sub-comparator 212 are coupled by a high-impedance path, and the influence of the noise 120 becomes large.

### SUMMARY

The present disclosure has been made in view of the above problems, and an exemplary general purpose of one embodiment is to provide a control circuit of a DC/DC converter in which an influence of noise is reduced.

1. One embodiment of the present disclosure relates to a control circuit of a DC/DC converter including a switching transistor. The control circuit includes: a first voltage dividing circuit structured to divide an output voltage of a DC/DC converter to generate a first feedback voltage; a second voltage dividing circuit structured to divide the output voltage of the DC/DC converter to generate a second feedback voltage; a first comparator structured to be enabled during a period in which a wake-up signal is asserted and asserts a first detection signal indicative of a comparison result between the first feedback voltage and a first threshold voltage; a second comparator structured to be always enabled and asserts a second detection signal indicative of a comparison result between the second feedback voltage and a second threshold voltage; and a logic circuit structured to generate a first pulse signal whose level transitions in response to the assertion of the first detection signal or the second detection signal, to assert the wake-up signal in a non-light load state, and to negate the wake-up signal in a light load state.

2. One embodiment of the present disclosure relates to a differential amplifier. The differential amplifier includes an enhancement type first NMOS transistor that receives an input voltage at a gate, a depression type second NMOS transistor whose gate is grounded, a current source provided between a source of the first NMOS transistor as well as a source of the second NMOS transistor and a ground, and a load circuit connected to a drain of the first NMOS transistor and a drain of the second NMOS transistor.

3. One embodiment of the present disclosure relates to a control circuit of a DC/DC converter including a switching transistor. The control circuit includes: a current detection circuit structured to generate a first current detection signal indicating a current flowing through the DC/DC converter; an offset circuit structured to generate a second current detection signal by superimposing, on the first current detection signal, an offset signal based on a comparison result between a feedback voltage according to an output voltage of the DC/DC converter and a reference voltage; and a main comparator structured to generate a turn-on signal according to a comparison result between a sum of the feedback voltage and the second current detection signal, and the reference voltage.

It is to be noted that any arbitrary combination or rearrangement of the above-described structural components and so forth is effective as and encompassed by the present embodiments. Moreover, this summary does not necessarily describe all necessary features so that the disclosure may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram of a DC/DC converter studied by the present inventors.

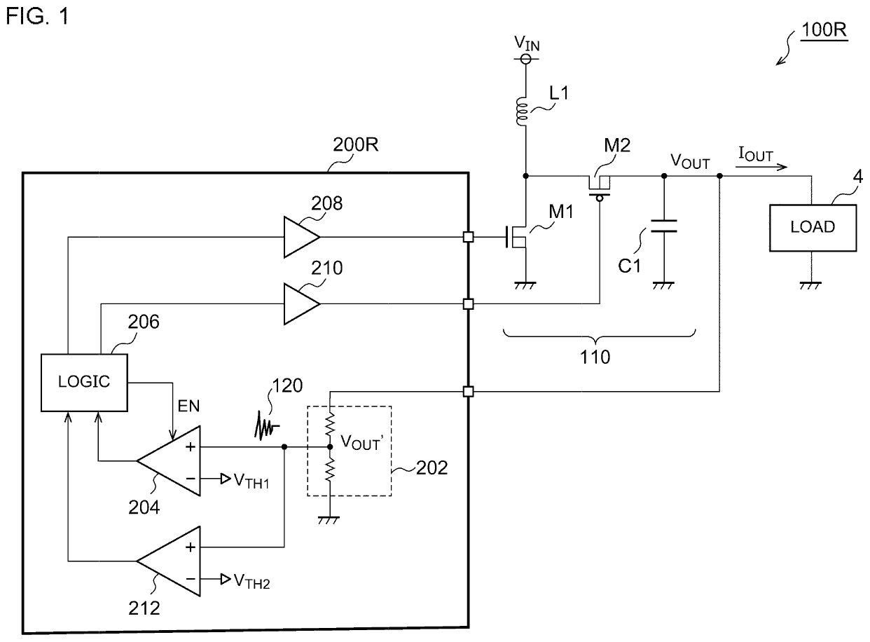

FIG. 2 is a circuit diagram of a DC/DC converter according to a first embodiment.

FIG. 3 is a circuit diagram illustrating a specific configuration example of a control circuit.

FIG. 4 is an operation waveform diagram of a DC/DC converter in a continuous current mode (a non-light load state).

FIG. 5 is an operation waveform diagram in a discontinuous current mode (a light load state).

FIG. 6A and FIG. 6B are waveform diagrams when a wake-up signal WAKE_UP changes from negation to assertion.

FIGS. 7A and 7B are circuit diagrams of a semiconductor integrated circuit that performs a voltage comparison.

FIG. 8 is a circuit diagram of a differential amplifier according to a second embodiment.

FIG. 9 is a circuit diagram of a differential amplifier according to Modification 1.

FIG. 10 is a circuit diagram of a differential amplifier according to Modification 2.

FIG. 11 is a circuit diagram of a differential amplifier according to Modification 3.

FIG. 12 is a circuit diagram of a DC/DC converter according to a modification.

FIG. 13 is a circuit diagram of a DC/DC converter according to a modification.

FIG. 14 is a circuit diagram of a linear regulator including a differential amplifier.

FIG. 15 is a circuit diagram of a conventional buck DC/DC converter of a ripple control method.

FIG. 16 is a circuit diagram of a DC/DC converter according to a third embodiment.

FIG. 17 is an operation waveform diagram of the DC/DC converter of FIG. 16.

FIG. 18A is a diagram illustrating a current-voltage characteristic of a comparative technique, and FIG. 18B is a diagram illustrating a current-voltage characteristic of the DC/DC converter according to the third embodiment.

FIG. 19 is a circuit diagram illustrating a turn-on signal generation circuit according to one embodiment.

FIG. 20 is a circuit diagram of a turn-on signal generation circuit according to one embodiment.

FIG. 21 is a circuit diagram of a turn-on signal generation circuit according to one embodiment.

FIG. 22 is a circuit diagram of a main comparator according to one embodiment.

FIG. 23 is a circuit diagram of a turn-on signal generation circuit according to one embodiment.

FIG. 24 is an equivalent circuit diagram of a main circuit of a DC/DC converter.

FIG. 25 is a circuit diagram showing a basic configuration of an ON time generation circuit.

FIG. 26 is an operation waveform diagram of the ON time generation circuit of FIG. 25.

FIG. 27 is a circuit diagram of an ON time generation circuit according to Example 1.

FIG. 28 is an operation waveform diagram of the ON time generation circuit of FIG. 27.

FIG. 29 is a circuit diagram of an ON time generation circuit according to Example 2.

FIG. 30 is an operation waveform diagram of the ON time generation circuit of FIG. 29.

FIG. 31 is a circuit diagram of an ON time generation circuit according to Example 3.

FIG. 32 is a circuit diagram of an ON time generation circuit according to Example 4.

### DETAILED DESCRIPTION

### Outline of Embodiments

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

1. One embodiment disclosed herein relates to a control circuit for a DC/DC converter including a switching transistor. The control circuit includes: a first voltage dividing circuit that divides an output voltage of a DC/DC converter to generate a first feedback voltage; a second voltage dividing circuit that divides the output voltage of the DC/DC converter to generate a second feedback voltage; a first comparator that is enabled during a period in which a wake-up signal is asserted and asserts a first detection signal indicative of a comparison result between a first feedback voltage and a first threshold voltage; a second comparator that is always enabled and asserts a second detection signal indicative of a comparison result between the second feedback voltage and a second threshold voltage; and a logic circuit that generates a first pulse signal whose level transitions in response to the assertion of the first detection signal or the second detection signal, asserts the wake-up signal in a non-light load state, and negates the wake-up signal in a light load state.

According to this configuration, by providing the first voltage dividing circuit and second voltage dividing circuit that are independent and correspond to the first comparator and the second comparator, it is possible to prevent noise generated at the time of switching enable/disable of the first comparator from being input to the second comparator, and it is possible to prevent malfunction of the DC/DC converter.

The control circuit may further include a current zero crossing detection circuit that detects a current zero crossing of an inductor of the DC/DC converter. The logic circuit may assert the wake-up signal after a predetermined time has elapsed from detection of the current zero crossing and negate the wake-up signal in response to the assertion of the next second detection signal. As a load current falls, the time from occurrence of the current zero crossing to the assertion of the first detection signal or the second detection signal becomes longer and eventually exceeds a predetermined time τ. Therefore, the light load state can be detected by measuring the time.

The current zero crossing detection circuit may include a comparator that is disabled during a period in which the wake-up signal is negated. As a result, power consumption can be further reduced.

The DC/DC converter is of a synchronous rectification type and may further include a synchronous rectification transistor. The logic circuit may generate a second pulse signal that transitions to an ON level when the first pulse signal transitions to an OFF level and transitions to the OFF level when the zero crossing occurs, and the control circuit may further include a second driver that drives the synchronous rectification transistor based on the second pulse signal. As a result, the DC/DC converter can be operated in a discontinuous current mode in the light load state.

The first voltage dividing circuit may include a switch that is turned on during a period in which the wake-up signal is asserted. As a result, in the light load state, the leakage current by the first voltage dividing circuit can be cut off.

The switch may be inserted into a ground side of the first voltage dividing circuit. As a result, after transition from the light load state to the non-light load state, the first threshold voltage rises from the ground, whereas the first feedback voltage falls from a high potential side. In other words, since the two input voltages approach from a separated state, chattering of the first comparator can be prevented.

A resistor constituting the first voltage dividing circuit may be larger than a resistor constituting the second voltage dividing circuit.

The first comparator may include an enhancement type first NMOS transistor, a depression type second NMOS transistor whose gate is grounded, a resistor provided between a source of the first NMOS transistor as well as a source of the second NMOS transistor and a ground, and a load circuit connected to a drain of the first NMOS transistor and a drain of the second NMOS transistor. In the first comparator, since a difference between a gate-source threshold voltage Vgs₍ₜₕ₎ of the first NMOS transistor and the second NMOS transistor is the second threshold voltage, a reference voltage source that generates the second threshold voltage is unnecessary, and the power consumption can be further reduced.

The load circuit may be a current mirror circuit.

The control circuit may be integrally integrated on one semiconductor substrate.

2. One embodiment relates to a differential amplifier. The differential amplifier includes an enhancement type first NMOS transistor that receives an input voltage at a gate, a depression type second NMOS transistor whose gate is grounded, a current source provided between a source of the first NMOS transistor as well as a source of the second NMOS transistor and a ground, and a load circuit connected to a drain of the first NMOS transistor and a drain of the second NMOS transistor.

In this differential amplifier, the input voltage can be compared with a threshold voltage determined based on the gate-source threshold voltage Vₜₕ₍ₑₙₕ₎ of the first NMOS transistor and the gate-source threshold voltage V_{th(dep)} of the second NMOS transistor. The reference voltage source that generates the threshold voltage is unnecessary, and the power consumption can be further reduced.

The current source may include a resistor. Accordingly, the differential amplifier can operate stand-alone without receiving a bias signal from outside. In other words, a bias circuit that generates the bias signal can be omitted, or the ON and OFF states of the bias circuit can be controlled independently of the differential amplifier, and the power consumption can be further reduced.

The current source may include a transistor. In this case, it is necessary to supply the bias signal to the transistor from outside, but a tail current can be adjusted.

The load circuit may be a current mirror circuit.

The load circuit may be a resistive load.

3. One embodiment relates to a control circuit of a DC/DC converter having a switching transistor. The control circuit includes: a current detection circuit that generates a first current detection signal indicating a current flowing through a DC/DC converter; an offset circuit that generates a second current detection signal by superimposing, on the first current detection signal, an offset signal based on a comparison result between a feedback voltage according to an output voltage of the DC/DC converter and a reference voltage; and a main comparator that generates a turn-on signal that triggers turn-on of a switching transistor based on a comparison result between a sum of the feedback voltage and the second current detection signal, and the reference voltage.

This configuration eliminates the need for an error amplifier, thereby reducing a current consumption.

The offset circuit may include an error detection comparator that compares the feedback voltage with the reference voltage. The offset signal may rise or fall according to an output of the error detection comparator.

The offset circuit may further include a counter that generates an offset signal whose count value rises or falls according to the output of the error detection comparator. The offset signal may correspond to the count value.

The current detection circuit may include a gm amplifier that amplifies a voltage across a current detection element provided on a current path, and an impedance circuit that converts an output current of the gm amplifier into a voltage signal. The offset circuit may include a current source that supplies a current signal corresponding to the count value to the impedance circuit.

The current detection circuit may include the gm amplifier that amplifies the voltage across the current detection element provided on the current path, and the impedance circuit that converts the output current of the gm amplifier into the voltage signal. The offset circuit may include a variable current source that is connected to the impedance circuit and rises or falls the amount of current based on the comparison result between the feedback voltage and the reference voltage.

The DC/DC converter may be a boost type that boosts the input voltage V_{IN} and generates an output voltage V_{OUT}.

The control circuit includes an ON time generation circuit that asserts a turn-off signal after a lapse of an ON time from turn-on of a switching transistor, a logic circuit that generates a pulse signal that transitions to an ON level when a turn-on signal is asserted and transitions to an OFF level when the turn-off signal is asserted, and a driver that drives the switching transistor according to the pulse signal.

The ON time may be proportional to (V_{OUT}−V_{IN})/V_{OUT}. A switching frequency can be stabilized by adaptively changing the ON time according to the input voltage and the output voltage.

The ON time generation circuit may include a first capacitor, a current source that is connected to the first capacitor and generates a current proportional to V_{OUT}, and a comparator that detects that a voltage change proportional to (V_{OUT}−V_{IN}) occurs in the first capacitor.

The current generated by the current source is I=α×V_{OUT}. The time T_{ON} required for the voltage change ΔV=β×(V_{OUT}−V_{IN}) proportional to (V_{OUT}−V_{IN}) to occur in the first capacitor is expressed as

T_{ON}=ΔV/I=β×(V_{OUT}−V_{IN})/(α×V_{OUT})=(β/α)×(V_{OUT}−V_{IN})/V_{OUT},

and the ON time proportional to (V_{OUT}−V_{IN})/V_{OUT} can be generated.

One end of the first capacitor may be grounded. The ON time generation circuit may further include a threshold voltage generation circuit that generates a threshold voltage according to (V_{OUT}−V_{IN}). The comparator may compare a voltage at the other end of the first capacitor with the threshold voltage.

The threshold voltage generation circuit may include a second capacitor. The threshold voltage generation circuit may charge the second capacitor with (V_{OUT}−V_{IN}) in the OFF state of the switching transistor, apply the switching voltage of a connection node between the inductor and the switching transistor to one end of the second capacitor in an ON period of the switching transistor, and set the voltage at the other end of the second capacitor as the threshold voltage. The switching voltage during the ON period is I×R_{ON1}. I is a current flowing through the switching transistor, and R_{ON1} is an ON resistance of the switching transistor. Therefore, according to this configuration, it is possible to generate the ON time in consideration of the ON resistance of the switching transistor.

The threshold voltage generation circuit may include a second capacitor, a first selector that applies an input voltage V_{IN} to one end of the second capacitor in the OFF state of the switching transistor and connects the one end of the second capacitor with the inductor of the DC/DC converter and the connection node of the switching transistor during an ON period of the switching transistor, and a second selector that applies an output voltage V_{OUT} to the other end of the second capacitor in the OFF state of the switching transistor and connects the other end of the second capacitor with the comparator during the ON period of the switching transistor. According to this configuration, it is possible to generate the ON time in consideration of the ON resistance of the switching transistor.

The threshold voltage generation circuit may include an inverter that inverts a switching voltage generated at an inductor of the DC/DC converter and a connection node of the switching transistor, and a filter that smooths an output of the inverter and generates a threshold voltage. According to this configuration, the ON time can be generated in consideration of the influence of the ON resistances of the switching transistor and the synchronous rectification transistor as well as the equivalent series resistance of the inductor.

The filter may be an RC filter. The threshold voltage generation circuit may charge the capacitor of the RC filter with V_{OUT}−V_{IN} while operating in the discontinuous current mode. According to this configuration, when returning from the discontinuous current mode to the continuous current mode, the operation can be resumed from an appropriate ON time.

The filter may be an RC filter including a resistor and a capacitor. The threshold voltage generation circuit may further include a third selector that applies an output voltage of the inverter to one end of the resistor during the continuous current mode and applies the output voltage V_{OUT} to one end of the resistor during the discontinuous current mode, and a fourth selector that applies a ground voltage to the other end of the capacitor during the continuous current mode and applies the input voltage V_{IN} to the other end of the capacitor during the discontinuous current mode. According to this configuration, when returning from the discontinuous current mode to the continuous current mode, the operation can be resumed from an appropriate ON time.

The input voltage V_{IN} may be applied to one end of the first capacitor. The comparator may compare the voltage at the other end of the first capacitor with the output voltage V_{OUT}. Since the ON resistance of the transistor and the equivalent series resistance of the inductor are ignored, the ON time can be generated with a simple configuration although the frequency at a heavy load becomes faster.

The control circuit may be integrally integrated on one semiconductor substrate. The term “integrally integrated” includes a case where all components of a circuit are formed on a semiconductor substrate and a case where main components of the circuit are integrally integrated, and some resistors, capacitors, and the like may be provided outside the semiconductor substrate for adjusting a circuit constant. By integrating the circuits on one chip, a circuit area can be reduced, and the characteristics of circuit elements can be kept uniform.

### EMBODIMENTS

Hereinafter, the present invention will be described based on preferred embodiments with reference to the drawings. The same or equivalent components, members, and processes illustrated in the drawings are denoted by the same reference numerals, and redundant description will be omitted as appropriate. Furthermore, the embodiments are not intended to limit the invention but are examples, and all features described in the embodiments and combinations thereof are not necessarily essential to the invention.

In the present description, “a state in which a member A is connected to a member B” includes not only a case where the member A and the member B are physically and directly connected to each other, but also a case where the member A and the member B are indirectly connected to each other via another member that does not substantially affect an electrical connection state between the member A and the member B or that does not impair a function or an effect exhibited by coupling between the two members.

Similarly, “a member C is provided between the member A and the member B” includes not only a case where the member A and the member C, or the member B and the member C are directly connected to each other, but also a case where the members are indirectly connected to each other via another member that does not substantially affect an electrical connection state between the members or that does not impair a function or an effect exhibited by the connection between the members.

In addition, “a signal A (voltage, current) is corresponding to a signal B (voltage, current)” means that the signal A has a correlation with the signal B. Specifically, it means (i) when the signal A is the signal B, (ii) when the signal A is proportional to the signal B, (iii) when the signal A is obtained by level-shifting the signal B, (iv) when the signal A is obtained by amplifying the signal B, (v) when the signal A is obtained by inverting the signal B, (vi) or any combination thereof, or the like. It is understood by a person skilled in the art that a range of “corresponding to” is determined according to types and applications of the signals A and B.

A vertical axis and a horizontal axis of a waveform diagram and a time chart referred to in the present description are appropriately enlarged and reduced for easy understanding, and each waveform shown is simplified or exaggerated or emphasized for easy understanding.

### First Embodiment

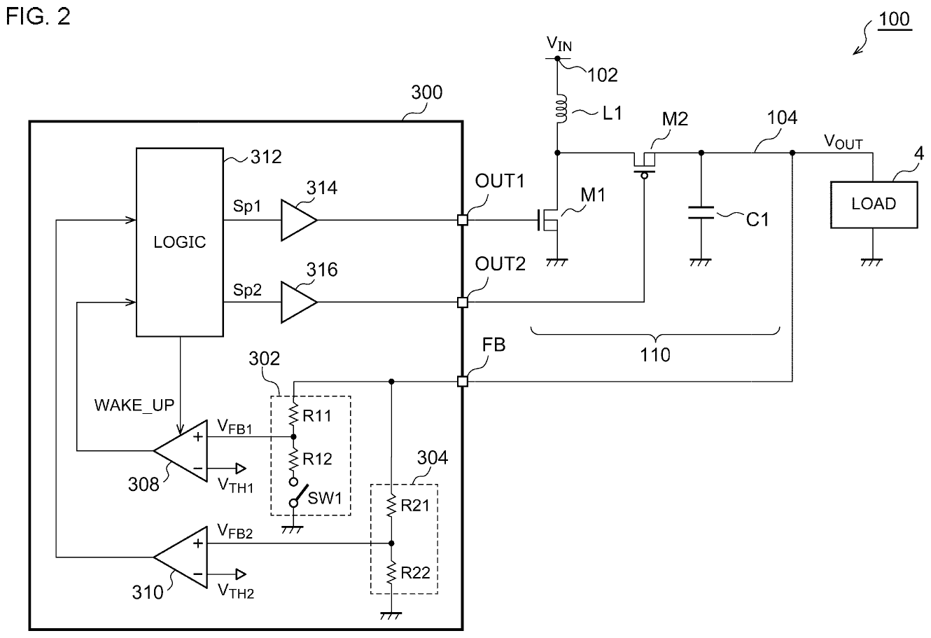

FIG. 2 is a circuit diagram of a DC/DC converter 100 according to a first embodiment. The DC/DC converter 100 is a boost converter, boosts the input voltage V_{IN} of an input terminal (input line) 102, stabilizes the input voltage V_{IN} to a predetermined voltage level, and supplies the voltage to a load 4 connected to an output terminal (output line) 104.

The DC/DC converter 100 includes an output circuit 110 and a control circuit 300.

The output circuit 110 includes an inductor L1, a switching transistor (a low-side transistor) M1, a synchronous rectification transistor (a high-side transistor) M2, and an output capacitor C1.

The control circuit 300 is a controller of a ripple control method, more specifically, a bottom detection method, and includes two output pins OUT1 and OUT2 and a feedback pin FB. A feedback voltage corresponding to the output voltage V_{OUT} of the DC/DC converter 100 is input to the feedback pin FB. The output pin OUT1 is connected to a gate of the switching transistor M1, and the output pin OUT2 is connected to a gate of the synchronous rectification transistor M2.

The control circuit 300 includes a first voltage dividing circuit 302, a second voltage dividing circuit 304, a first comparator 308, a second comparator 310, a logic circuit 312, a first driver 314, and a second driver 316, and is an integrated circuit (IC) integrated on one semiconductor substrate.

The first voltage dividing circuit 302 includes resistors R11 and R12 and divides the output voltage V_{OUT} fed back to the feedback pin FB to generate a first feedback voltage V_{FB1}. Preferably, the first voltage dividing circuit 302 includes a switch SW1 provided in series with the resistors R11 and R12.

The second voltage dividing circuit 304 includes resistors R21 and R22 and divides the output voltage V_{OUT} of the DC/DC converter 100 to generate a second feedback voltage V_{FB2}.

The resistors R21 and R22 constituting the second voltage dividing circuit 304 can be made larger than the resistors R11 and R12 constituting the first voltage dividing circuit 302. Accordingly, the leakage current of the second voltage dividing circuit 304 can be reduced.

The logic circuit 312 asserts the wake-up signal WAKE_UP (for example, high) in the non-light load state of the DC/DC converter 100 and negates (for example, low) the wake-up signal WAKE_UP in the light load state.

The first comparator 308 is enabled while the wake-up signal WAKE_UP is asserted. In an enabled state, the first comparator 308 asserts a first detection signal S1 (for example, high) according to the comparison result between the first feedback voltage V_{FB1} and a first threshold voltage V_{TH1}. The first detection signal S1 is asserted when V_{FB1} falls below Vim. The first comparator 308 is configured to enable a high-speed voltage comparison in the enabled state and has large power consumption in exchange. In a disabled state, the first comparator 308 is configured such that the operation stops, and the power consumption approaches substantially zero.

The switch SW1 of the first voltage dividing circuit 302 is also controlled according to the wake-up signal WAKE_UP, and while the first comparator 308 is in the disabled state, the switch SW1 is turned off, and the leakage current through the first voltage dividing circuit 302 is reduced.

The second comparator 310 is always enabled regardless of the state of the load 4 of the DC/DC converter 100. The second comparator 310 asserts the second detection signal S2 indicative of a comparison result between the second feedback voltage V_{FB2} and a second threshold voltage V_{TH2}. The second detection signal S2 is asserted (for example, high) when V_{FB2} falls below V_{TH2}.

The second comparator 310 is configured to have very small power consumption instead of having a response speed lower than that of the first comparator 308.

The logic circuit 312 generates a first pulse signal Sp1 whose level transitions when the first detection signal S1 or the second detection signal S2 is asserted. The first pulse signal Sp1 is a signal used to drive the switching transistor M1, and transitions to an ON level when the first detection signal S1 or the second detection signal S2 is asserted. After transitioning to the ON level, the first pulse signal Sp1 transitions to an OFF level after a predetermined ON time T_{ON} (or ON time adaptively changed based on the input voltage V_{IN} and the output voltage V_{OUT}) elapses.

The first driver 314 drives the switching transistor M1 in accordance with the first pulse signal Sp1.

The logic circuit 312 generates a second pulse signal Sp2 instructing on/off of the synchronous rectification transistor M2. When the first pulse signal Sp1 transitions to the OFF level, the second pulse signal Sp2 transitions to the ON level. In addition, the second pulse signal Sp2 transitions to an OFF level when the first detection signal S1 or the second detection signal S2 is asserted during a period in which the DC/DC converter 100 operates in the continuous current mode. In a period during which the DC/DC converter 100 operates in the discontinuous current mode, the second pulse signal Sp2 transitions to the OFF level when the current flowing through the inductor L1 becomes zero.

The above is the configuration of the control circuit 300. In the control circuit 300, the first voltage dividing circuit 302 and the second voltage dividing circuit 304 that are independent are provided corresponding to the first comparator 308 and the second comparator 310. Accordingly, the noise generated at the time of switching enable/disable of the first comparator 308 can be prevented from being input to the second comparator 310, and malfunction of the DC/DC converter 100 can be prevented.

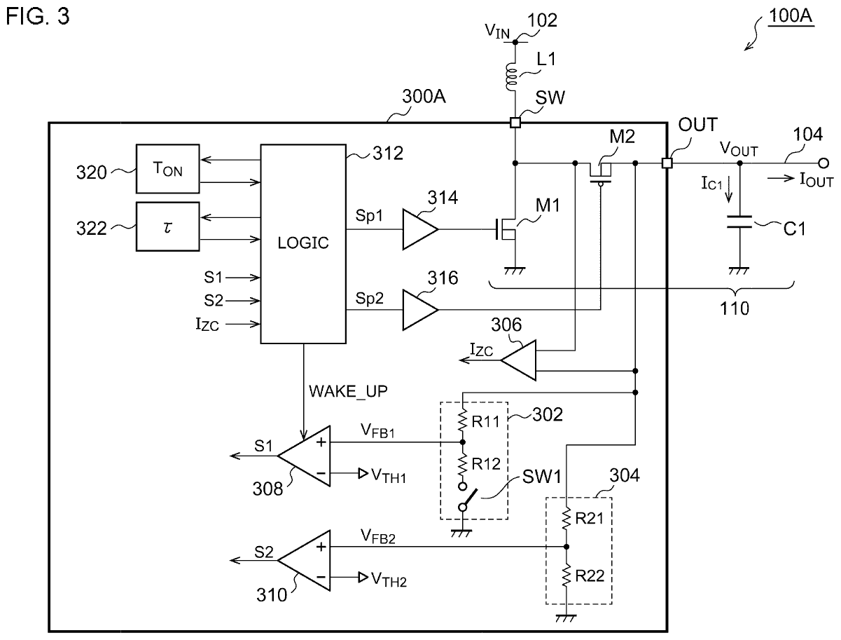

FIG. 3 is a circuit diagram illustrating a specific configuration example (300A) of the control circuit 300. The switching transistor M1 and the synchronous rectification transistor M2 are integrated in the control circuit 300A, and an output pin OUT and a switching pin SW are provided instead of the OUT1 pin, the OUT2 pin, and the FB pin in FIG. 2. The switching pin SW is connected to the inductor L1, and the output pin OUT is connected to the output capacitor C1.

In order to detect the transition between the continuous current mode and the discontinuous current mode, a current zero crossing detection circuit 306 is provided. The current zero crossing detection circuit 306 detects the zero crossing of a current I_{L} flowing through the inductor L1 of the DC/DC converter 100. For example, the current zero crossing detection circuit 306 may include a zero crossing comparator that monitors the current flowing through the synchronous rectification transistor M2 and asserts a zero cross detection signal IZC when the current crosses a threshold value near zero. Although not limited thereto, the zero crossing comparator may detect a current zero crossing point by comparing a voltage drop across the synchronous rectification transistor M2 with a threshold voltage near zero.

The zero cross detection signal IZC is input to the logic circuit 312 together with the first detection signal S1 and the second detection signal S2.

The control circuit 300 includes an ON time timer 320 and a light load detection timer 322. The logic circuit 312 generates the first pulse signal Sp1, the second pulse signal Sp2, and the wake-up signal WAKE_UP using the ON time timer 320 and the light load detection timer 322.

Next, the operation of the logic circuit 312 will be described for each of the continuous current mode (CCM) and the discontinuous current mode (DCM).

### Continuous Current Mode

When the first detection signal S1 is asserted, the logic circuit 312 causes the first pulse signal Sp1 to transition to the ON level. In addition, the ON time timer 320 is activated to measure the ON time T_{ON}, and after the ON time T_{ON} elapses, the first pulse signal Sp1 is caused to transition to the OFF level, and the second pulse signal Sp2 is caused to transition to the ON level.

Next, when the first detection signal S1 is asserted, the logic circuit 312 causes the second pulse signal Sp2 to transition to the OFF level and causes the first pulse signal Sp1 to transition to the ON level.

### Discontinuous Current Mode

When the first detection signal S1 is asserted, the logic circuit 312 causes the first pulse signal Sp1 to transition to the ON level. In addition, the ON time timer 320 is activated to measure the ON time T_{ON}, and after the ON time T_{ON} elapses, the first pulse signal Sp1 is caused to transition to the OFF level, and the second pulse signal Sp2 is caused to transition to the ON level.

When the current zero crossing signal IZC is subsequently asserted, the logic circuit 312 causes the second pulse signal Sp2 to transition to the OFF level. Thereafter, both the switching transistor M1 and the synchronous rectification transistor M2 are turned off, and the switching is stopped.

In the light load state, the output voltage V_{OUT} slowly falls. In the light load state, the first comparator 308 is disabled, and only the second comparator 310 is active. Therefore, when the feedback voltage V_{FB2} falls to the threshold voltage V_{TH2}, the output S2 of the second comparator 310 is asserted. In response to the assertion of the second detection signal S2, the logic circuit 312 switches the first pulse signal Sp1 to the ON level.

Next, generation of the wake-up signal WAKE_UP by the logic circuit 312 will be described.

The logic circuit 312 negates the wake-up signal WAKE_UP after a lapse of the predetermined time T with assertion of the current zero crossing signal IZC (occurrence of current zero crossing) as a trigger. Then, in response to the next assertion of the second detection signal S2, the wake-up signal WAKE_UP is asserted.

Note that it is preferable to stop the circuit blocks other than the first comparator 308 based on the wake-up signal WAKE_UP. Specifically, the current zero crossing detection circuit 306 may be disabled during a period in which the wake-up signal WAKE_UP is negated. This can further reduce the power consumption.

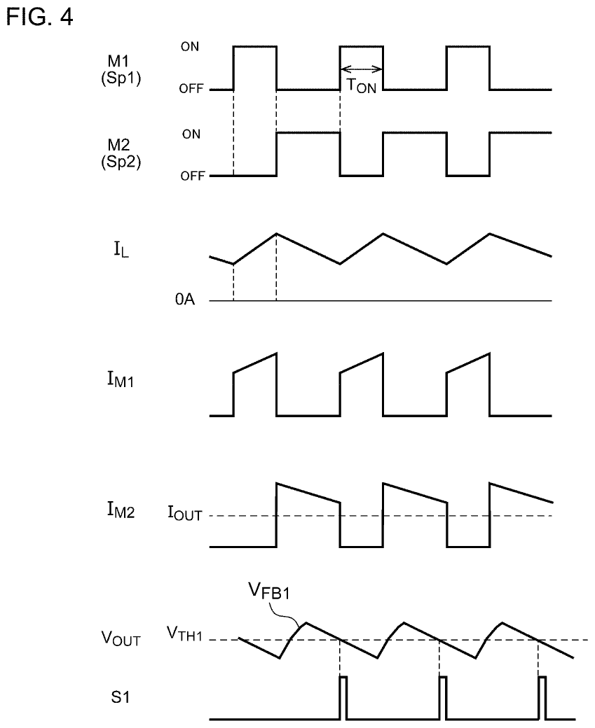

Next, the operation of the control circuit 300A will be described. FIG. 4 is an operation waveform diagram of the DC/DC converter 100A in a continuous current mode (a non-light load state). I_{L}, I_{M1}, and I_{M2} indicate currents flowing through the inductor, the switching transistor M1, and the synchronous rectification transistor M2, respectively.

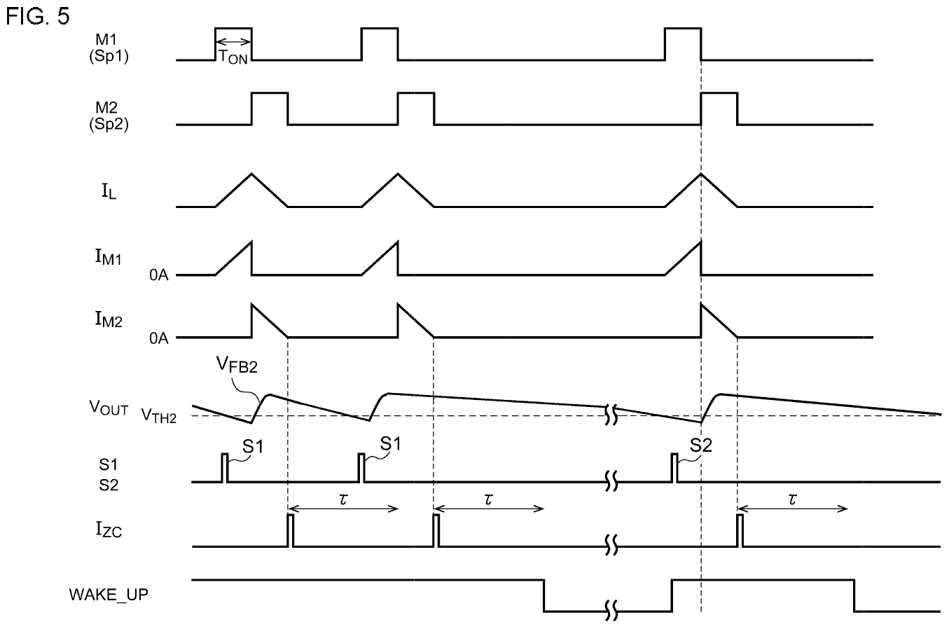

FIG. 5 is an operation waveform diagram in a discontinuous current mode (a light load state). In the light load state, the decreasing speed of the output voltage V_{OUT} rises, and the time from the timing of the current zero crossing to the assertion of the next second detection signal S2 becomes long. When this time exceeds the predetermined threshold time τ, the wake-up signal WAKE_UP is negated, the first comparator 308 is disabled, and the power consumption is reduced.

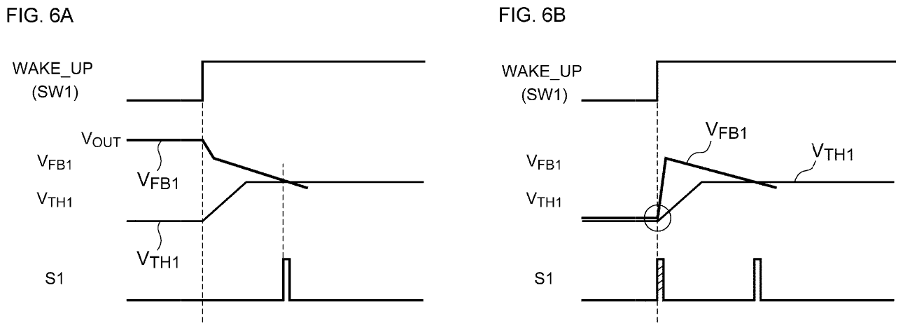

FIG. 6A and FIG. 6B are waveform diagrams when the wake-up signal WAKE_UP changes from negation to assertion. FIG. 6A is a waveform when the switch SW1 of the first voltage dividing circuit 302 is inserted to a low potential side as illustrated in FIG. 2 and FIG. 3. For comparison, FIG. 6B is a waveform when the switch SW1 is inserted into the high potential side of the first voltage dividing circuit 302.

As illustrated in FIG. 6B, in a case where the switch SW1 is inserted on the high potential side, the feedback voltage V_{FB1} becomes 0 V when the switch SW1 is off. Then, when the wake-up signal WAKE_UP is asserted and the switch SW1 is turned on, the feedback voltage V_{FB1} rises from 0 V, and the threshold voltage V_{TH1} also rises from 0 V. Therefore, there is a possibility that the two voltages V_{FB1} and the threshold voltage V_{TH1} cross unnecessarily in a circled portion in the drawing, and the first detection signal S1 is erroneously asserted (hatched).

On the other hand, in a case where the switch SW1 is inserted to the low potential side, the feedback voltage V_{FB1} becomes the output voltage V_{OUT} when the switch SW1 is off. Then, when the wake-up signal WAKE_UP is asserted and the switch SW1 is turned on, the feedback voltage V_{FB1} transitions from V_{OUT} to V_{OUT}×R12/(R11+R12), and then falls following the output voltage V_{OUT}. In other words, immediately after the assertion of the wake-up signal WAKE_UP, the feedback voltage V_{FB1} falls, the threshold voltage V_{TH1} rises, and they change in the opposite direction. Therefore, it is possible to prevent the first detection signal S1 from being erroneously asserted due to unnecessary crossing.

The technology described so far is not limited to a synchronous rectification DC/DC converter and can also be applied to a diode rectification DC/DC converter. In addition, the DC/DC converter may be a buck type or a boost-buck type.

In the following second embodiment, a differential amplifier will be described. As described above, the response speed is not required for the second comparator 310, but since the second comparator continues to operate at all times, it is required to reduce the power consumption as much as possible. Hereinafter, a differential amplifier 400 that can be suitably used as the second comparator 310 will be described.

### Second Embodiment

### Differential Amplifier

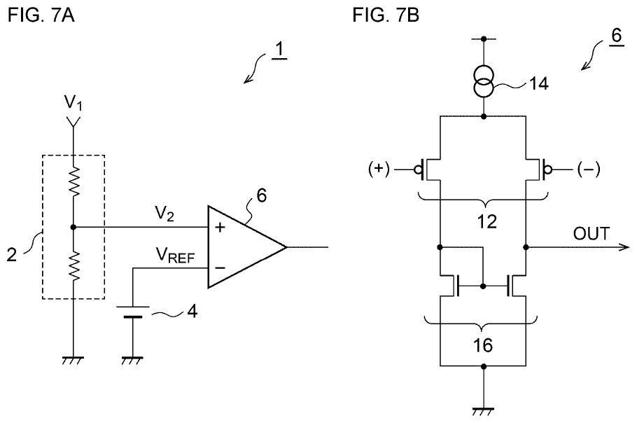

In a semiconductor integrated circuit, a voltage comparison processing of comparing a certain voltage with a reference voltage is frequently performed. A voltage comparator is used for the voltage comparison that requires high accuracy. FIG. 7A and FIG. 7B are circuit diagrams of semiconductor integrated circuits that perform the voltage comparison. A semiconductor integrated circuit 1 includes a resistance voltage dividing circuit 2, a reference voltage source 4, and a voltage comparator 6. The resistance voltage dividing circuit 2 divides a voltage V₁ that is target to be monitored. The reference voltage source 4 includes a band gap reference circuit and the like and generates a reference voltage V_{REF} (or a threshold voltage) that does not depend on a temperature and a power supply voltage. The voltage comparator 6 compares a divided voltage V₂ with the reference voltage V_{REF} and outputs a signal corresponding to the comparison result. When a voltage division ratio (gain) of the resistance voltage dividing circuit 2 is α, V₂=α×V₁. Thus, the output of the voltage comparator shows the result of comparing V₁ with V_{REF}′=V_{REF}/α.

FIG. 7B illustrates a configuration example of the voltage comparator 6. The voltage comparator 6 includes a differential amplifier 10. The differential amplifier 10 includes an input differential pair 12, a tail current source 14, and a load circuit 16.

In the semiconductor integrated circuit 1 of FIG. 7A, a current is consumed in both the reference voltage source 4 and the voltage comparator 6. In a device in which it is difficult to replace or charge a battery such as an Internet of Things (IoT) device, it is desirable to reduce power consumption of a circuit as extremely as possible.

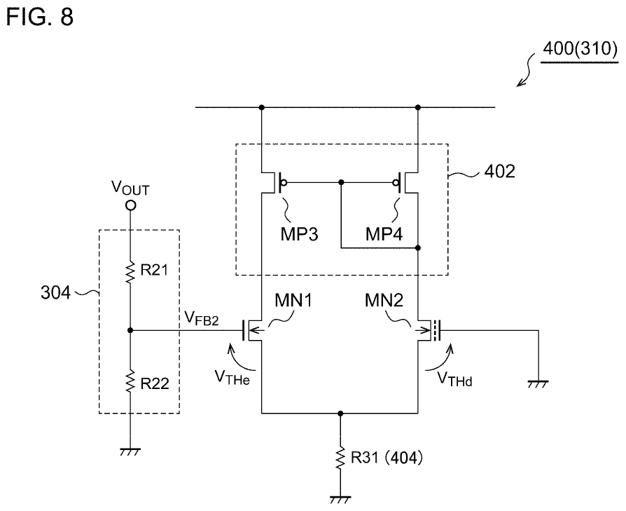

FIG. 8 is a circuit diagram of the differential amplifier 400 according to the second embodiment. The differential amplifier 400 includes a first NMOS transistor MN1, a second NMOS transistor MN2, a current source 404, and a load circuit 402.

The first NMOS transistor MN1 is of an enhancement type, and an input voltage V_{IN} is input to a gate of the first NMOS transistor MN1. The threshold voltage Vₜₕ₍ₑₙₕ₎ of the first NMOS transistor MN1 is positive. The second NMOS transistor MN2 is of a depression type, and a gate of the second NMOS transistor MN2 is grounded. The threshold voltage V_{th(dep)} of the second NMOS transistor MN2 is negative. The transistors MN1 and MN2 form a differential pair.

The current source 404 includes a resistor R31. The resistor R31 is provided between the source of the first NMOS transistor as well as the source of the second NMOS transistor and the ground. The resistor R31 acts like a tail current source.

The load circuit 402 is connected to a drain of the first NMOS transistor and a drain of the second NMOS transistor. The load circuit 402 is a current mirror circuit (current mirror load) and includes PMOS transistors MP3 and MP4.

The above is the configuration of the differential amplifier 400. Next, the operation will be described.

Since the gate of the depression type second NMOS transistor MN2 is grounded, the source voltage thereof is −(V_{th(dep)})=+|V_{th(dep)}|. This voltage is applied to the resistor R, and I=|V_{th(deP)}|/R31 flows through the resistor R and acts as a tail current source.

Focusing on the first NMOS transistor MN1, the first NMOS transistor MN1 is turned off when V_{IN}>|V_{th(dep)}|+Vₜₕ₍ₑₙₕ₎, and the first NMOS transistor MN1 is turned on when V_{IN}<|V_{th(deP)}|+Vₜₕ₍ₑₙₕ₎.

In other words, an effective threshold voltage V_{TH2} of the differential amplifier 400 is V_{TH2}=Vₜₕ₍ₑₙₕ₎+|V_{th(dep)}|=Vₜₕ₍ₑₙₕ₎−V_{th(dep)}, and the output of the differential amplifier 400 is a signal according to a magnitude relationship between the input voltage V_{IN} and the threshold voltage V_{TH2}.

According to the differential amplifier 400, the power consumption can be reduced as extremely as possible. In addition, means for generating the threshold voltage V_{TH2} is inherent in the differential amplifier 400, and an external voltage source is unnecessary, so that the power consumption can be further reduced.

Furthermore, since the resistor R31 is used as a tail current source, it is not necessary to provide a bias signal from outside, and the operation can be performed stand-alone. In other words, the bias circuit that generates the bias signal can be omitted, or the ON and OFF states of the bias circuit can be controlled independently of the voltage comparator, and thus the power consumption can be further reduced.

Next, a modification of the differential amplifier 400 will be described.

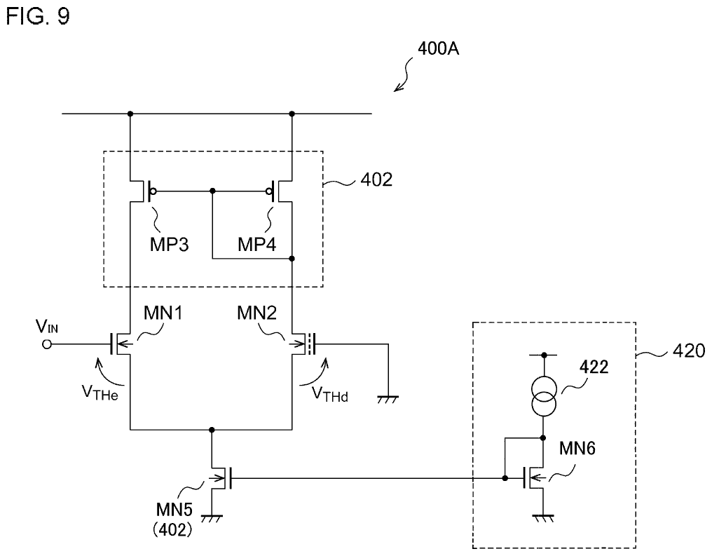

FIG. 9 is a circuit diagram of a differential amplifier 400A according to Modification 1. In Modification 1, a tail current source 404 includes a transistor MN5. The gate of the transistor MN5 is connected to a bias circuit 420 including a constant current source 422. Specifically, the bias circuit 420 includes a transistor MN6 provided on the path of the constant current source 422, and the transistors MN6 and MN5 form a current mirror circuit.

In Modification 1, a bias state of the differential amplifier 400A can be adjusted by the bias circuit 420. However, since the bias circuit 420 needs to be always operated while the differential amplifier 400A is operated, the differential amplifier 400 of FIG. 8 is better in terms of power consumption.

### Modification 2

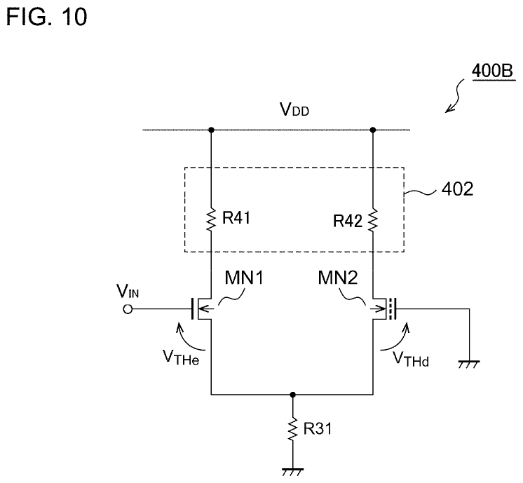

FIG. 10 is a circuit diagram of a differential amplifier 400B according to Modification 2. In Modification 2, the load circuit 402 is a resistive load and includes resistors R41 and R42.

### Modification 3

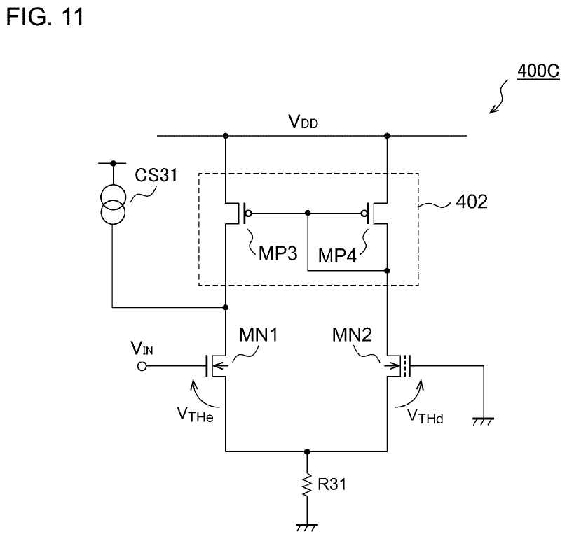

FIG. 11 is a circuit diagram of a differential amplifier 400C according to Modification 3. The differential amplifier 400C includes a current source CS31. The current source CS31 sources an offset current IOFS to at least one of the drains of the first NMOS transistor MN1 and the drain of the second NMOS transistor MN2. The effective threshold voltage V_{TH2} of the differential amplifier 400C can be finely adjusted by the offset current IOFS.

The application of the differential amplifier described with reference to FIG. 8 to FIG. 11 is not limited to the DC/DC converter described above, and the differential amplifier can be widely used for a semiconductor integrated circuit whose power consumption needs to be reduced.

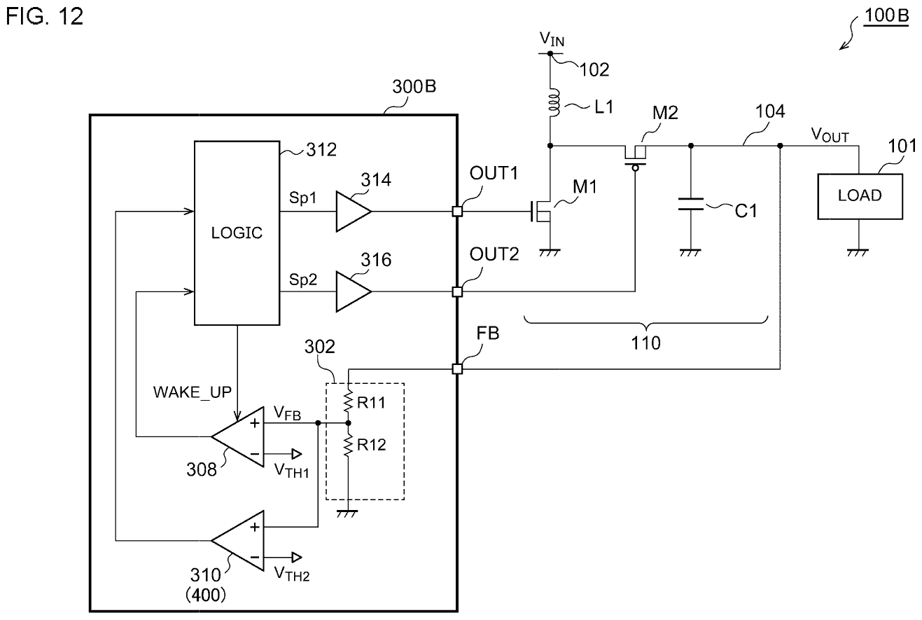

FIG. 12 is a circuit diagram of a DC/DC converter according to a modification. In a control circuit 300B, the second voltage dividing circuit 304 in FIG. 3 is omitted, only the first voltage dividing circuit 302 is provided, and the switch SW1 is omitted. A common feedback signal V_{FB} is input to the first comparator 308 and the second comparator 310. Also in this configuration, the power consumption can be reduced by using the differential amplifier 400 (400A to 400C) described above as the second comparator 310.

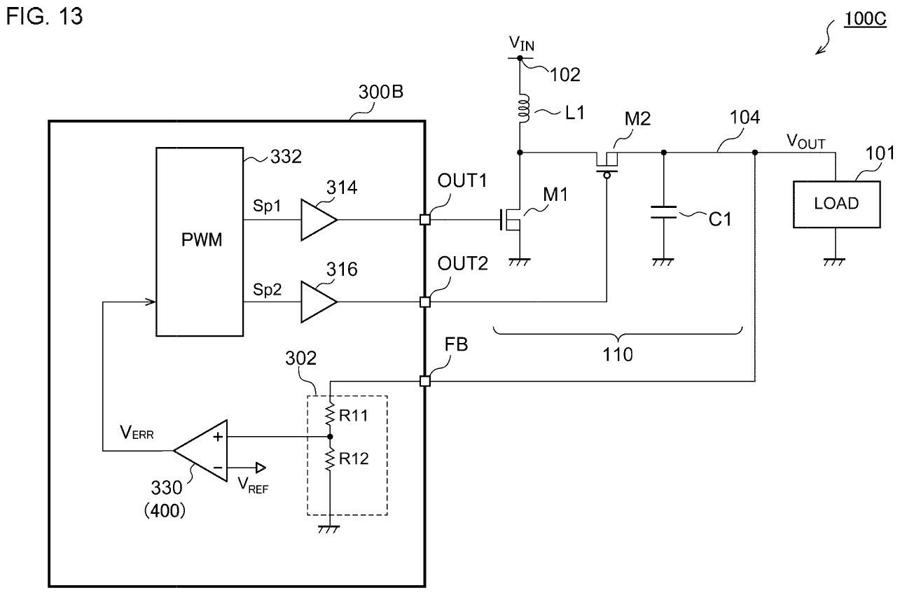

In addition, the application of the differential amplifier 400 is not limited to the comparator and can also be used as an error amplifier. FIG. 13 is a circuit diagram of a DC/DC converter 100C according to a modification. The DC/DC converter 100C includes an error amplifier 330 and a pulse modulator 332 instead of the comparator and the logic circuit. The error amplifier 330 includes the differential amplifier 400 (400A to 400C) described above, amplifies an error between the feedback signal V_{FB} and the reference voltage V_{REF}, and generates an error signal V_{ERR}. The reference voltage V_{REF} is equal to the effective threshold voltage V_{TH2} when the differential amplifier 400 is used as a comparator, and thus, V_{REF}=Vₜₕ₍ₑₙₕ₎+|V_{th(dep)}|=Vₜₕ₍ₑₙₕ₎−V_{th(dep)}.

The pulse modulator 332 generates pulse signals Sp1 and Sp2 whose duty ratio, frequency, ON time, or OFF time changes according to the error signal V_{ERR}. The pulse modulator 332 may include a voltage comparator that compares the error signal V_{ERR} with a triangular wave or a sawtooth wave (a voltage mode). Furthermore, this voltage comparator may be configured by the differential amplifier 400.

Alternatively, the pulse modulator 332 may be a modulator in a peak current mode or an average current mode. In this case, the pulse signals Sp1 and Sp2 are generated such that an average value or a peak value of a coil current flowing through the main circuit approaches the error signal V_{ERR}.

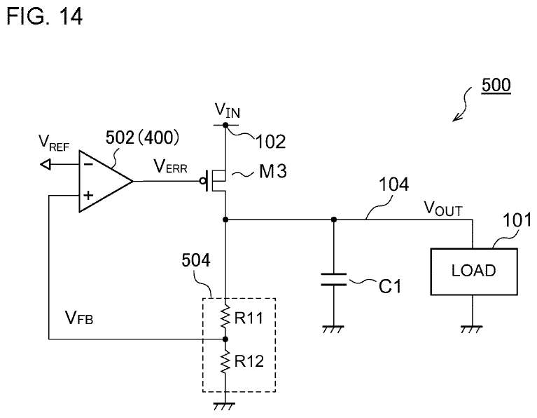

FIG. 14 is a circuit diagram of a linear regulator 500 including the differential amplifier 400. The linear regulator 500 (low drop output: LDO) stabilizes the output voltage V_{OUT} obtained by stepping down the voltage V_{IN} of an input line 102 to a predetermined voltage level and supplies the output voltage V_{OUT} to a load 101 connected to an output line 104. The linear regulator 500 includes a transistor M3, an error amplifier 502, and a resistance voltage dividing circuit 504. The error amplifier 502 includes the differential amplifier 400 described above. The error amplifier 502 amplifies an error between the feedback signal V_{FB} generated by the resistance voltage dividing circuit 504 and the reference voltage V_{REF} and supplies the amplified error to the gate of the transistor M3. The reference voltage V_{REF} is equal to the effective threshold voltage V_{TH2} when the differential amplifier 400 is used as a comparator, and thus, V_{REF}=Vₜₕ₍ₑₙₕ₎+|V_{th(dep)}|=Vₜₕ₍ₑₙₕ₎−V_{th(dep)}. By using the differential amplifier 400 as the error amplifier, the power consumption of the linear regulator can be reduced.

### Third Embodiment

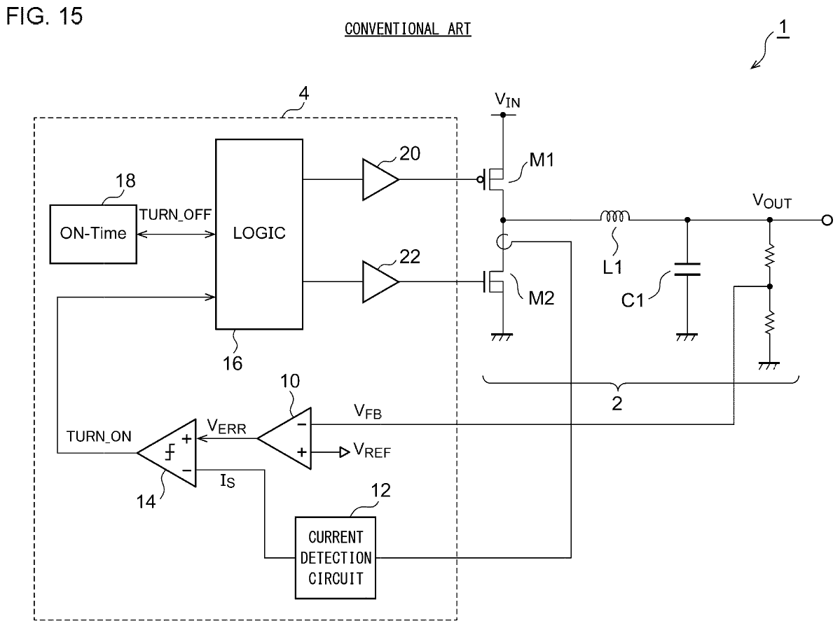

FIG. 15 is a circuit diagram of a buck DC/DC converter using a conventional ripple control method. A DC/DC converter 1 includes a main circuit 2 of the DC/DC converter and a controller 4 of a constant ON time (COT) system of a current mode.

The main circuit 2 includes the switching transistor M1 (the high-side transistor), the synchronous rectification transistor (the low-side transistor) M2, the inductor L1, and the capacitor C1.

An error amplifier 10 amplifies an error between the feedback voltage V_{FB} corresponding to the output voltage V_{OUT} of a DC/DC converter 2 and the reference voltage V_{REF} defining a target value thereof, and generates the error signal V_{ERR}. A current detection circuit 12 generates a current detection signal IS indicating a current flowing through the synchronous rectification transistor M2. A main comparator 14 compares the current detection signal I_{S} with the error signal V_{ERR} and asserts a turn-on signal TURN_ON when the current detection signal I_{S} falls to the error signal V_{ERR}.

A logic circuit 16 turns on the switching transistor M1 and turns off the synchronous rectification transistor M2 in response to the turn-on signal TURN_ON. Then, an ON time generator 18 is started, and a constant ON time T_{ON} is measured. When a turn-off signal TURN_OFF is asserted after the ON time T_{ON} has elapsed, the logic circuit 16 turns off the switching transistor M1 and turns on the synchronous rectification transistor M2. Drivers 20 and 22 drive the switching transistor M1 and the synchronous rectification transistor M2 according to the pulse signal generated by the logic circuit 16.

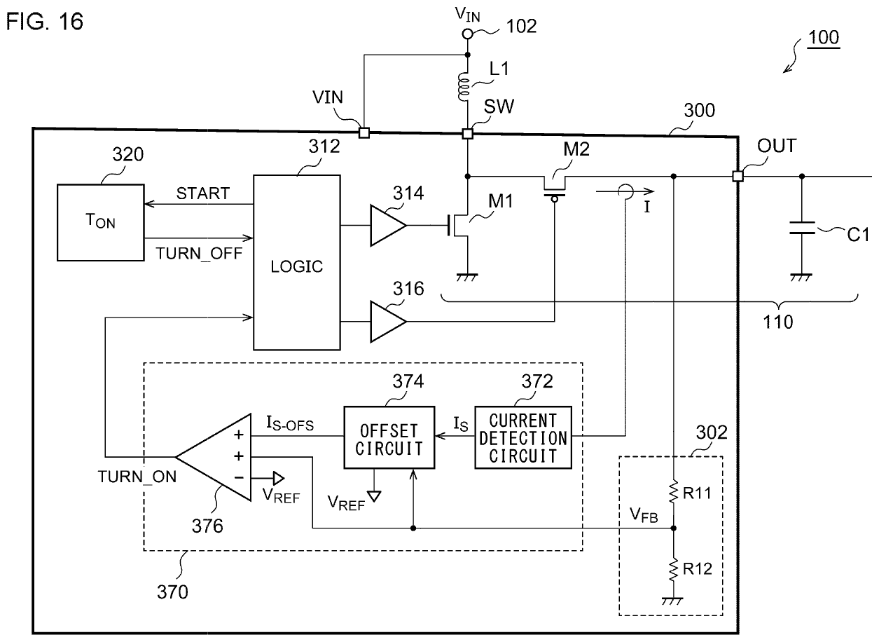

FIG. 16 is a circuit diagram of the DC/DC converter 100 according to the third embodiment. The DC/DC converter 100 is a boost converter, boosts an input voltage V_{IN} of the input line (the input terminal) 102, stabilizes the input voltage V_{IN} to a predetermined voltage level, and supplies the voltage to a load connected to the output line (output terminal) 104.

The DC/DC converter 100 includes a main circuit 110 and the control circuit 300. The main circuit 110 includes the inductor L1, the switching transistor (the low-side transistor) M1, the synchronous rectification transistor (the high-side transistor) M2, and the output capacitor C1.

The control circuit 300 is a controller using a ripple control method and includes the switching pin SW and the output pin OUT. An external inductor L1 is connected to the switching pin SW, and an external output capacitor C1 and the output line 104 are connected to the output pin OUT.

The control circuit 300 includes the voltage dividing circuit 302, a turn-on signal generation circuit 370, an ON time generation circuit 320, the logic circuit 312, the first driver 314, the second driver 316, the switching transistor M1, and the synchronous rectification transistor M2, and is an integrated circuit (IC) integrated on one semiconductor substrate.

The voltage dividing circuit 302 includes the resistors R11 and R12 and divides the output voltage V_{OUT} to generate the feedback voltage V_{FB}.

The turn-on signal generation circuit 370 compares the feedback voltage V_{FB} corresponding to the output voltage V_{OUT} of the DC/DC converter 100 with the reference voltage V_{REF} and asserts the turn-on signal TURN_ON when the feedback voltage V_{FB} falls below the reference voltage V_{REF}.

The turn-on signal generation circuit 370 includes a current detection circuit 372, an offset circuit 374, and a main comparator 376.

The current detection circuit 372 generates a first current detection signal IS indicating a current flowing through the main circuit 110 of the DC/DC converter 100. The current detected by the current detection circuit 372 is a current I_{M2} flowing through the synchronous rectification transistor M2 and is the current flowing during an OFF period of the switching transistor M1. An average current of the current I_{M2} is an output current IOUT.

The configuration of the current detection circuit 372 is not particularly limited, but for example, the voltage across (the drain-source voltage) the synchronous rectification transistor M2 may be amplified to generate the first current detection signal IS. Alternatively, a current sense resistor may be inserted in series with the synchronous rectification transistor M2, and a voltage drop across the current sense resistor may be amplified to generate the first current detection signal IS.

The first current detection signal IS, the reference voltage V_{REF}, and the feedback voltage V_{FB} are input to the offset circuit 374. The offset circuit 374 compares the feedback voltage V_{FB} with the reference voltage V_{REF}, superimposes the offset signal I_{OFS} according to the comparison result on the first current detection signal IS, and generates a second current detection signal I_{S_OFS}.

I_{S_OFS}=I_{S}−I_{OFS}

A comparison timing between the two voltages V_{FB} and V_{REF} in the offset circuit 374 is provided during the ON period of the synchronous rectification transistor M2 (the OFF period of the switching transistor M1). For example, the comparison timing may be immediately before the switching transistor M1 is actually turned on.

The main comparator 376 receives the feedback voltage V_{FB} and the second current detection signal I_{S_OFS} as inputs of a first polarity (+), receives the reference voltage V_{REF} as an input (−) of a second polarity, and generates the turn-on signal TURN_ON that triggers the turn-on of the switching transistor M1. The turn-on signal TURN_ON is based on a result of comparing the sum of the feedback voltage V_{FB} and the second current detection signal I_{S_OFS} with the reference voltage V_{REF}. From another viewpoint, the turn-on signal TURN_ON is based on a comparison result between the feedback voltage V_{FB} and a difference between the reference voltage V_{REF} and the second current detection signal I_{S_OFS}. These are merely differences in expression and are equivalent.

In the configuration example of FIG. 16, when V_{FB} I_{S_OFS}>V_{REF}, the turn-on signal TURN_ON is high, and when V_{FB}+I_{S_OFS}<V_{REF}, the turn-on signal TURN_ON is low, and low of the turn-on signal TURN_ON is assertion, and high is negation. In a case where the corrected reference voltage is set as V_{REF}′=V_{REF}−I_{S_OFS}, the turn-on signal TURN_ON becomes high when V_{FB}>V_{REF}′, and the turn-on signal TURN_ON becomes low when V_{FB}<V_{REF}′.

The ON time generation circuit 320 generates the turn-off signal TURN_OFF to be asserted after the elapse of the ON time T_{ON} from the turn-on of the switching transistor M1. The ON time T_{ON} may be a predetermined constant time or may be adaptively controlled according to the state of the DC/DC converter 100. The turn-off signal TURN_OFF is a trigger for turning off the switching transistor M1.

The ON time generation circuit 320 can be configured by a timer circuit. The logic circuit 312 supplies a start signal START that triggers an operation start to the ON time generation circuit 320. The start signal START is a signal indicating a turn-on of the switching transistor M1. The start signal START may be the first pulse signal Sp1.

The logic circuit 312 generates the pulse signals Sp1 and Sp2 instructing the turn-on and turn-off of the switching transistor M1 and the synchronous rectification transistor M2 based on the turn-on signal TURN_ON and the turn-off signal TURN_OFF.

When the turn-on signal TURN_ON is asserted, the logic circuit 312 causes the first pulse signal Sp1 to transition to the ON level (high).

When the turn-off signal TURN_OFF is asserted, the logic circuit 312 causes the first pulse signal Sp1 to transition to the OFF level (low).

In the continuous current mode (CCM), the logic circuit 312 complementarily changes the second pulse signal Sp2 with the first pulse signal Sp1. In the discontinuous current mode (DCM), the zero crossing of the current flowing through the synchronous rectification transistor M2 is detected, and the OFF levels of both the first pulse signal Sp1 and the second pulse signal Sp2 are maintained from the current zero crossing to the assertion of the next turn-on signal TURN_ON.

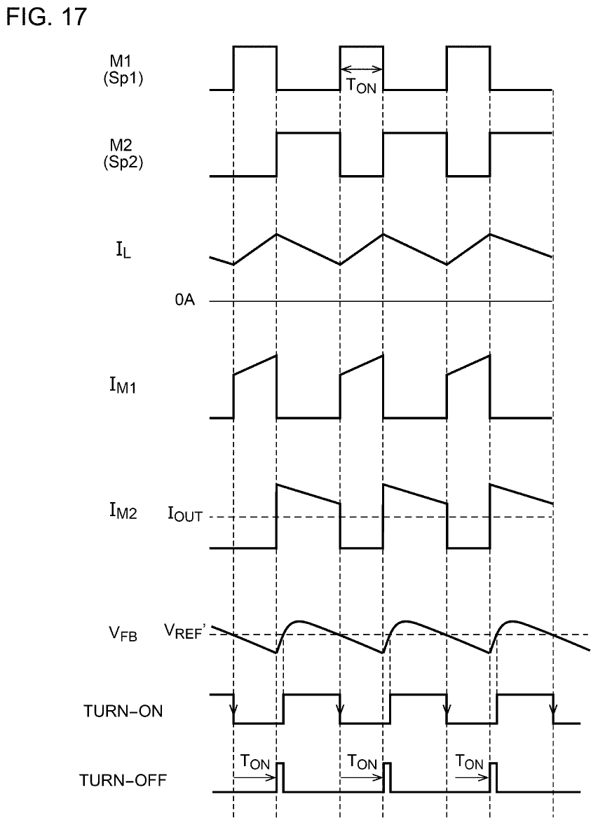

The above is the configuration of the control circuit 300. Next, the operation will be described. FIG. 17 is an operation waveform diagram of the DC/DC converter 100 of FIG. 16. I_{L}, I_{M1}, and I_{M2} respectively indicate currents flowing through the inductor, the switching transistor M1, and the synchronous rectification transistor M2. V_{REF}′=V_{REF}−I_{S_OFS}=V_{REF}−I_{S}+I_{OFS}, and the reference voltage V_{REF}′ rises and falls based on the first current detection signal I_{S} determined according to the load current I_{OUT} and the offset signal I_{OFS} adjusted according to the comparison result between V_{FB} and V_{REF}. When the feedback voltage V_{FB} falls below the reference voltage V_{REF}′, the switching transistor M1 is turned on, and after the ON time T_{ON} has elapsed, the switching transistor M1 is turned off.

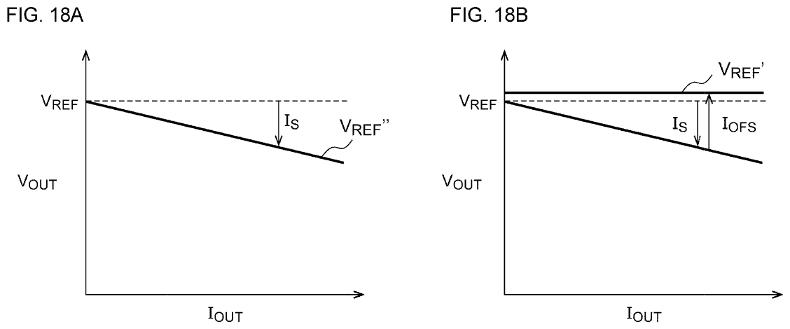

The above is the operation of the control circuit 300. FIG. 18A is a diagram illustrating a current-voltage characteristic of a comparative technique, and FIG. 18B is a diagram illustrating a current-voltage characteristic of the DC/DC converter 100 according to the third embodiment.

To start with, the comparison technique will be described with reference to FIG. 18A. The comparison technique has a configuration in which the offset circuit 374 is omitted from the DC/DC converter 100 of FIG. 16, and the turn-on signal TURN_ON is generated based on the comparison result between the feedback voltage V_{FB} and the reference voltage V_{REF}″=V_{REF}−I_{S}. Since a ripple component (a slope component) of the first current detection signal I_{S} is superimposed on the reference voltage V_{REF}″, the circuit operation can be stabilized.

However, when the load current I_{OUT} rises, the first current detection signal I_{S} rises, and thus the reference voltage V_{REF}″ falls. Therefore, as the load current I_{OUT} rises, the average level of the feedback voltage V_{FB}, that is, the output voltage V_{OUT} falls. In other words, in the comparative technique, there is a problem that a load regulation is deteriorated.

FIG. 18B will be referred to. In the present embodiment, the reference voltage V_{REF}′=V_{REF}−(I_{S}−I_{OFS}) is expressed. The offset signal I_{OFS} is adjusted according to a comparison result between the original reference voltage V_{REF} and the feedback voltage V_{FB} such that an error between the reference voltage V_{REF} and the feedback voltage V_{FB} becomes small, that is, V_{REF} and V_{FB} approach each other. As a result, immediately after the load current I_{OUT} fluctuates, V_{REF}′ deviates from the reference voltage V_{REF}, but thereafter, by optimizing the offset signal I_{OFS} based on the offset circuit 374, the reference voltage V_{REF}′ approaches a constant value based on the original reference voltage V_{REF}.

As a result, in a steady state, the output voltage V_{OUT} is stabilized to a constant voltage independent of the load current I_{OUT}, and the load regulation can be improved. Also in the present embodiment, since the ripple component (the slope component) of the first current detection signal I_{S} is injected into a feedback loop, stability of the circuit is improved similarly to the comparative technique.

Since the control circuit 300 does not include the error amplifier, the current consumption can be reduced as compared with a configuration including the error amplifier.

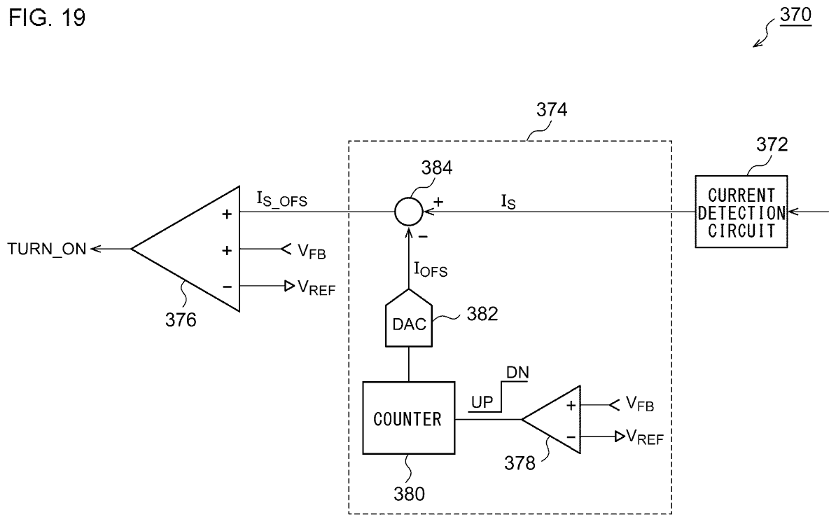

FIG. 19 is a circuit diagram illustrating the turn-on signal generation circuit 370 according to one embodiment. The offset circuit 374 includes an error detection comparator 378, a counter 380, and a D/A converter 382. The error detection comparator 378 compares the feedback voltage V_{FB} with the reference voltage V_{REF}. The offset signal I_{OFS} rises or falls according to the output of the error detection comparator 378.

The counter 380 is an up/down counter, and its count value rises or falls according to the output UP/DN of the error detection comparator 378. The D/A converter 382 converts the count value of the counter 380 into an analog offset signal I_{OFS}.

An adding means 384 subtracts the first current detection signal I_{S} and the offset signal I_{OFS} to generate I_{S_OFS}=I_{S}−I_{OFS}.

At a determination timing of each switching cycle, when V_{FB}>V_{REF}, the counter 380 performs a down operation, and the offset signal I_{OFS} falls. The second current detection signal I_{S_OFS} rises, and V_{REF}′ falls. Accordingly, feedback is applied in a direction in which the feedback voltage V_{FB} falls and approaches the reference voltage V_{REF}.

On the contrary, at the determination timing, when V_{FB}<V_{REF}, the counter 380 performs an up operation, and the offset signal I_{OFS} rises. The corrected second current detection signal I_{S_OFS} falls, and V_{REF}′ rises. Accordingly, feedback is applied in a direction in which the feedback voltage V_{FB} rises and approaches the reference voltage V_{REF}.

As described above, according to the present embodiment, the feedback voltage V_{FB} can be brought close to the reference voltage V_{REF}.

Focusing on the operation of the offset circuit 374, the corrected second current detection signal I_{S_OFS} includes the ripple component (the slope component) of the first current detection signal I_{S}, and a DC component is adjusted such that an error between the feedback voltage V_{FB} and the reference voltage V_{REF} approaches zero.

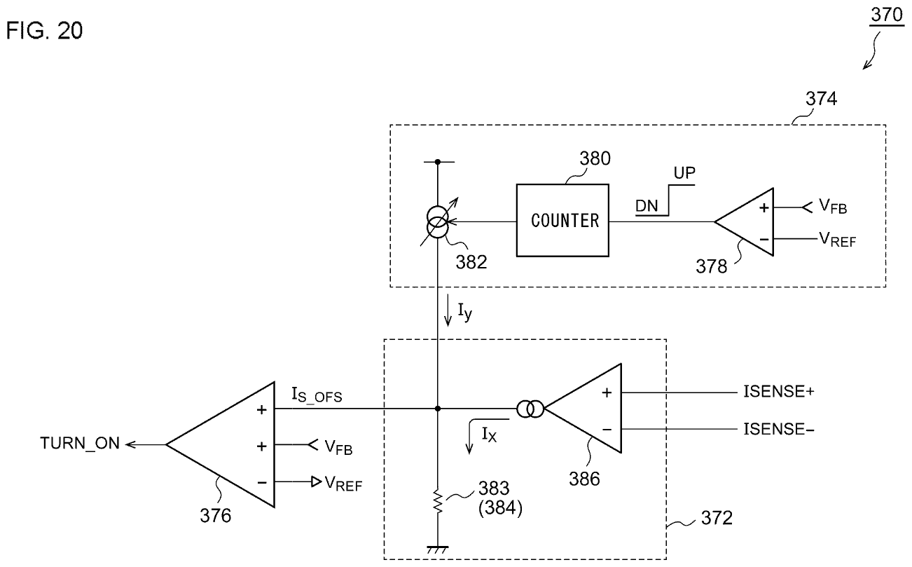

FIG. 20 is a circuit diagram of the turn-on signal generation circuit 370 according to one embodiment. The current detection circuit 372 includes a gm amplifier 386 and a resistor 388. The current detection circuit 372 receives voltages of an ISENSE+ terminal and an ISENSE− terminal. The ISENSE+ terminal is, for example, one end of the synchronous rectification transistor M2 (the switching terminal SW) in FIG. 16, and the ISENSE− terminal is the other end (the output terminal OUT) of the synchronous rectification transistor M2. In a case where the current sense resistor is provided, ISENSE+ and ISENSE− are connected to both ends of the current sense resistor.

The gm amplifier 386 amplifies the voltage drop of the synchronous rectification transistor M2 and outputs a current signal Iₓ. The current signal Iₓ is converted into a first current detection signal I_{S} by the resistor 388.

The D/A converter 382 is a current DAC and converts the count value of the counter 380 into a current signal I_{y}. The D/A converter 382 may be a variable current source. The current signal I_{y} flows through the resistor 388. The resistor 388 functions as the adding means 384 in FIG. 19. The current signal I_{y} and the current signal Iₓ are added in the resistor 388. The second current detection signal I_{S_OFS} is expressed by the following equation.

I_{S_OFS}=(Iₓ+I_{y})×R=I_{S}+I_{OFS}

Accordingly, the offset signal I_{OFS} may rise when V_{FB}>V_{REF}, and the offset signal I_{OFS} may fall when V_{FB}<V_{REF}.

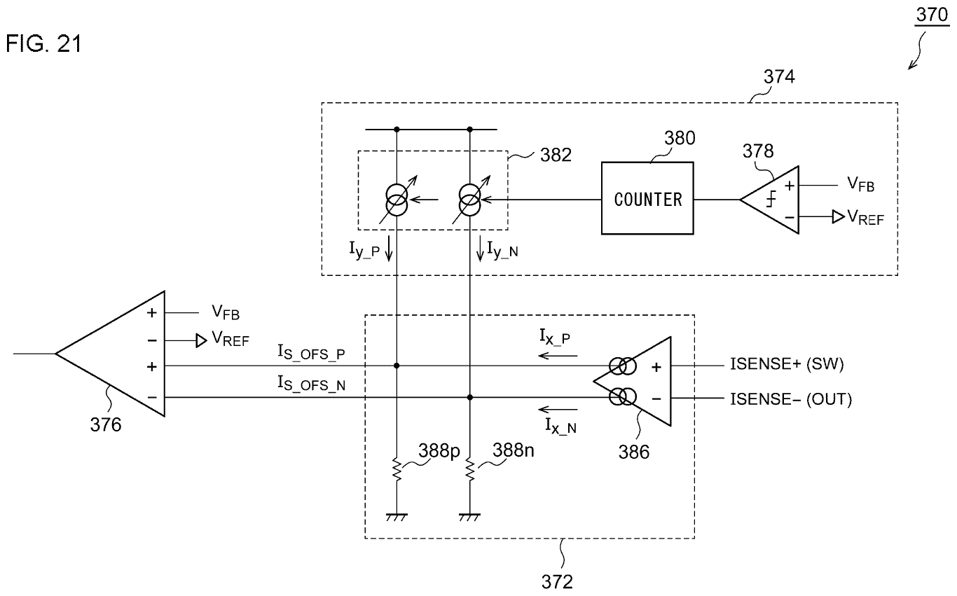

FIG. 21 is a circuit diagram of the turn-on signal generation circuit 370 according to one embodiment. The turn-on signal generation circuit 370 of FIG. 21 is obtained by changing the turn-on signal generation circuit 370 of FIG. 20 to a differential circuit.

The current detection circuit 372 includes a differential gm amplifier 386 and resistor pairs 388p and 388n. The current detection circuit 372 receives voltages of the ISENSE+ terminal and the ISENSE− terminal and outputs differential currents I_{x_P} and I_{x_N}. The differential currents I_{x_P} and I_{x_N} are converted into voltage signals I_{S_P} and I_{S_N} by the resistor pairs 388p and 388n. I_{S_P}−I_{S_N} corresponds to I_{S} in FIG. 20.

The D/A converter 382 is a differential current DAC, and outputs differential currents I_{y_P} and I_{y_N} according to the count value of the counter 380. I_{y_P}−I_{y_N} corresponds to I_{y} in FIG. 20. The differential currents I_{y_P} and I_{y_N} are supplied to the resistor pairs 388p and 388n, combined with the differential currents I_{x_P} and I_{x_N}, and converted into second differential current detection signals I_{S_OFS_P} and I_{S_OFS_N} that are voltage signals. A difference between the second differential current detection signals I_{S_OFS_P} and I_{S_OFS_N} corresponds to I_{S_OFS} in FIG. 21.

The main comparator 376 includes four inputs and is configured to be able to compare the sum of the signals of the two positive input terminals with the sum of the signals of the two negative input terminals. V_{FB} and I_{S_OFS_P} are input to the positive input terminals, and V_{REF} and I_{S_OFS_N} are input to the negative input terminals. Therefore, in the main comparator 376, the magnitude relationship between the two voltages V_{FB}+I_{S_OFS_P} and V_{REF}+I_{S_OFS_N} is compared.

In FIG. 21, the D/A converter 382 may be changed to a differential output configuration.

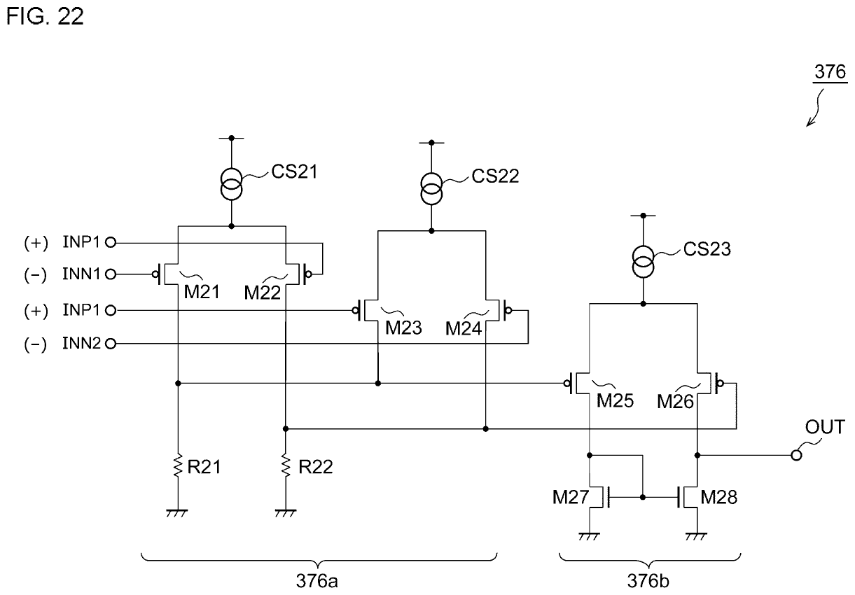

FIG. 22 is a circuit diagram of the main comparator 376 according to one embodiment. The main comparator 376 includes a differential amplifier 376A at a preceding stage and a comparator 376B at a subsequent stage. In the differential amplifier 376A in the preceding stage, the signals of the two positive input terminals are added together, and the signals of the two negative input terminals are added together. Therefore, the differential amplifier 376A at the preceding stage can be regarded as an adder.

The differential amplifier 376A includes a first input differential pair M21 and M22 and second input differential pair M23 and M24 having the load circuits R21 and R22 in common. Tail current sources CS21 and CS22 supply a tail current to the corresponding input differential pair. The load circuits R21 and R22 may be current mirrors.

The comparator 376b in the subsequent stage compares output signals of the differential amplifier 376a in the preceding stage. The comparator 376b includes a tail current source CS23, differential pairs M25 and M26, and current mirror loads M27 and M28.

Note that by fixing the voltage of one input of the comparator with the four inputs in FIG. 22, the comparator may be used as a comparator with three inputs in FIGS. 16, FIG. 19, FIG. 20, and the like.

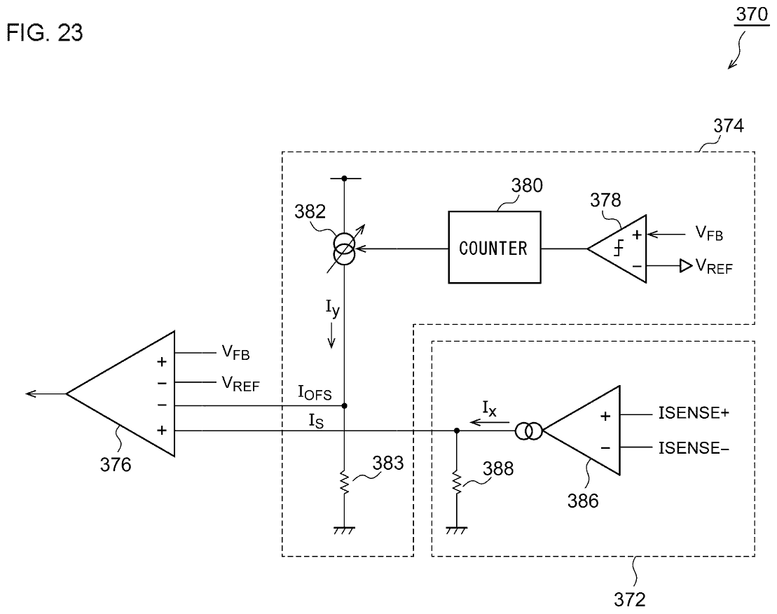

FIG. 23 is a circuit diagram of the turn-on signal generation circuit 370 according to one embodiment. In the offset circuit 374, the current generated by the D/A converter 382 is converted into a voltage signal I_{OFS} in a resistor 383. In this embodiment, the first current detection signal I_{S} and the offset signal I_{OFS} are combined in the main comparator 376. In a case where the main comparator 376 has the configuration of FIG. 22, the differential amplifier 376a in the preceding stage corresponds to the adding means 384.

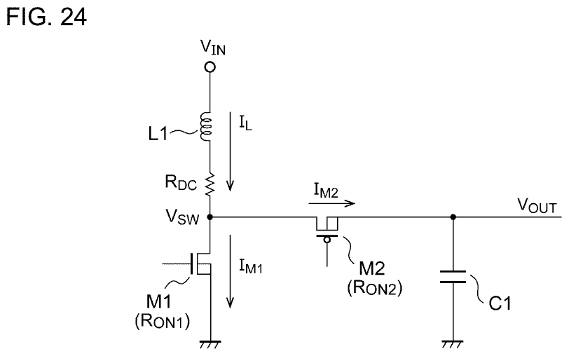

FIG. 24 is the equivalent circuit diagram of the main circuit 110 of the DC/DC converter 100. R_{DC} is an equivalent series resistance such as the inductor L1 and wiring. R_{ON1} represents the ON resistance of the switching transistor M1, and R_{ON2} represents the ON resistance of the synchronous rectification transistor M2.

A switching cycle is defined as T. In an ON state φ_{ON} of the switching transistor M1, I_{L}=I_{M1}, and the voltage across the inductor L1 is {V_{IN}−(R_{ON1}+R_{DC})×I_{L}}. Accordingly, an increase in width ΔI_{ON} of an inductor current I_{L} in the ON state φ_{ON} is expressed by Equation (1). T_{ON} is a length of the ON state and is referred to as the ON time.

ΔI_{ON}=T_{ON}/L×{V_{IN}−(R_{ON1}+R_{DC})×I_{L}} (1)

In the OFF state φ_{OFF} of the switching transistor M1, I_{L}=I_{M2}, and the voltage across the inductor L1 is {V_{OUT}+(R_{ON1}+R_{DC})×I_{L}−V_{IN}}. Accordingly, a decrease in width ΔI_{OFF} of the inductor current I_{L} in the OFF state φ_{OFF} is expressed by Equation (2).

ΔI_{OFF}=(T−T_{ON})/L×{V_{OUT}+(R_{ON2}+R_{DC})×I_{L}−V_{IN}} (2)

When the output voltage V_{OUT} is stabilized in the continuous current mode, ΔI_{ON}=ΔI_{OFF} holds. Accordingly, a duty cycle d is expressed by Equation (3).

$$d = {T}_{ON} / T = \{ {V}_{OUT} - {V}_{IN} + ( {R}_{ON 2} + {R}_{D C} ) \times {I}_{L} \} / \{ {V}_{OUT} - ( {R}_{ON 1} - {R}_{ON 2} ) \times {I}_{L} \} \qquad ( 3 )$$

Assuming R_{ON1}=R_{ON2}=R_{DC}=0, Equation (4) is obtained.

$$d = {T}_{ON} / T = \{ {V}_{OUT} - {V}_{IN} \} / {V}_{OUT} \qquad ( 4 )$$

Therefore, when a target period in a non-overcurrent state is Tp_{(REF)}, the ON time generation circuit 320 of the control circuit 300 calculates

T_{ON}={V_{OUT}−V_{IN}}/V_{OUT}×T_{REF}

to generate the ON time T_{ON} satisfying the equation above. This makes it possible to keep the switching frequency of the DC/DC converter 100 constant.

Next, a configuration of the ON time generation circuit 320 will be described based on some embodiments.

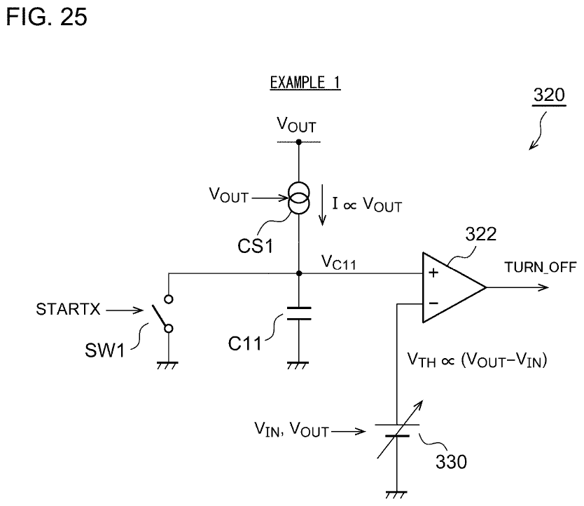

FIG. 25 is a circuit diagram illustrating a basic configuration of the ON time generation circuit 320. The ON time generation circuit 320 includes a first capacitor C11, a current source CS12, a comparator 322, and a threshold voltage generation circuit 330.

The current source CS12 is connected to the first capacitor C11 and generates a current I (∝V_{OUT}) proportional to V_{OUT}. For example, the current source CS12 may be a V/I conversion circuit. The comparator 322 monitors the voltage V_{C11} between both ends of the first capacitor C11 and detects that a voltage changes proportional to (V_{OUT}−V_{IN}) has occurred.

In FIG. 25, one end of the first capacitor C11 is grounded. The threshold voltage generation circuit 330 generates a threshold voltage V_{TH}∝(V_{OUT}−V_{IN}) proportional to (V_{OUT}−V_{IN}). The comparator 322 compares the voltage V_{C11} at the other end of the first capacitor C11 with the threshold voltage V_{TH}. The switch SW1 is connected in parallel with the first capacitor C11 and is controlled according to a start signal START_B.

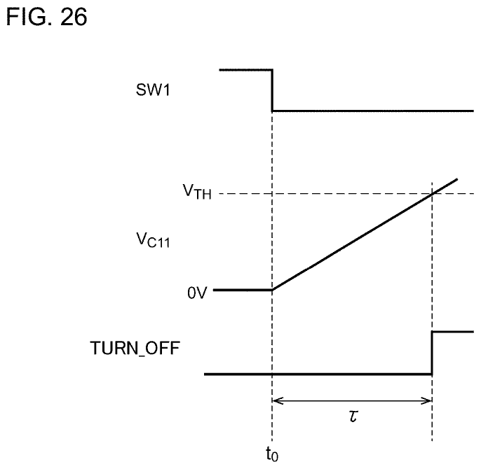

FIG. 26 is an operation waveform diagram of the ON time generation circuit 320 in FIG. 25. Before time t₀, the start signal START_B is high, and the voltage V_{C11} of the first capacitor C11 is 0 V. When the start signal START_B transitions from high to low at the time to, the first capacitor C11 is charged by the current I generated by the current source CS12, and the voltage V_{C11} of the first capacitor C11 rises with a slope proportional to the current I.

I=αV_{OUT}

The voltage V_{C11} of the capacitor after a lapse of time t from the time t₀ is expressed by Equation (5).

V_{C11}=αV_{OUT}×t/C11 (5)

It is assumed that the threshold voltage V_{TH} is V_{TH}=β×(V_{OUT}−V_{IN}). When the time until a capacitor voltage V_{C11} reaches the threshold voltage V_{TH} is represented by τ, Equation (6) holds.

αV_{OUT}×τ/C11=β×(V_{OUT}−V_{IN}) (6)

When this is solved for τ, Equation (7) is obtained.

τ=α/β×C11×(V_{OUT}−V_{IN})/V_{OUT} (7)

Therefore, according to the ON time generation circuit 320 in FIG. 25, it is possible to generate the turn-off signal TURN_OFF that changes after the lapse of the time τ proportional to (V_{OUT}−V_{IN})/V_{OUT} after the start signal START_B changes. By driving the DC/DC converter 100 with the time τ as the ON time T_{ON}, the switching frequency can be stabilized.

### Example 1

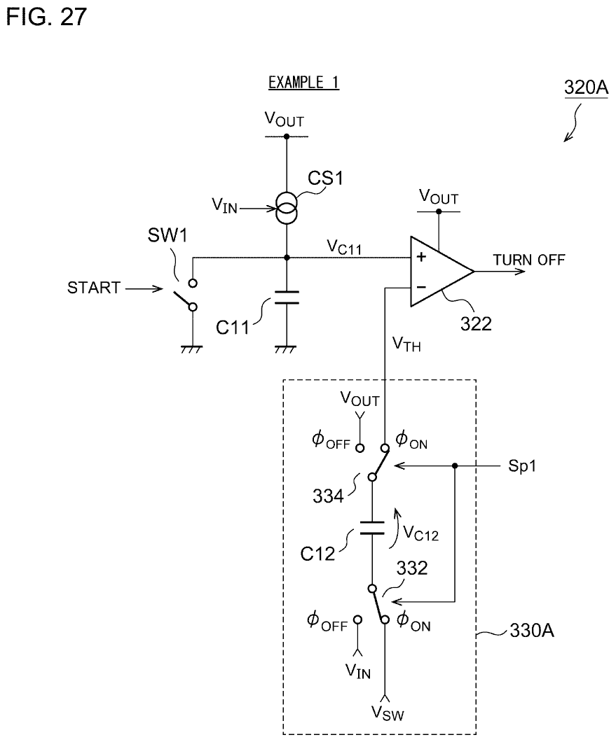

FIG. 27 is a circuit diagram of an ON time generation circuit 320A according to Example 1. The threshold voltage generation circuit 330A includes a second capacitor C12.

The threshold voltage generation circuit 330A charges the second capacitor C12 with (V_{OUT}−V_{IN}) in the OFF state φ_{OFF} of the switching transistor M1. In addition, in the ON state φ_{ON} of the switching transistor M1, the threshold voltage generation circuit 330A applies the voltage (switching voltage) V_{SW} of the switching pin SW, which is the connection node between the inductor L1 and the switching transistor M1, to one end of the second capacitor C12, and supplies the voltage at the other end of the second capacitor C12 to the comparator 322 as the threshold voltage V_{TH}.

For example, the threshold voltage generation circuit 330 includes a first selector 332 and a second selector 334 in addition to the second capacitor C12. The first selector 332 applies the input voltage V_{IN} to one end of the second capacitor C12 in the OFF state φ_{OFF} of the switching transistor M1 and connects one end of the second capacitor C12 to the switching pin SW of the DC/DC converter 100 in the ON state φ_{ON} of the switching transistor M1.

The second selector 334 applies the output voltage V_{OUT} to the other end of the second capacitor C12 in the OFF state of the switching transistor M1 and connects the other end of the second capacitor C12 to the comparator 322 in the ON state φ_{ON} of the switching transistor M1.

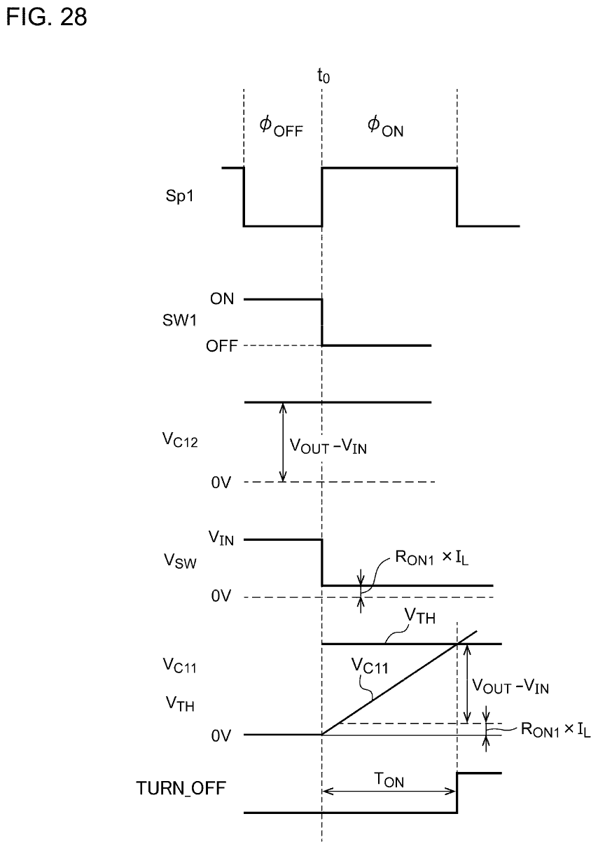

The above is the configuration of the ON time generation circuit 320A. FIG. 28 is an operation waveform diagram of the ON time generation circuit 320A in FIG. 27. Before the time t₀, the OFF state φ_{OFF} is set, and the second capacitor C12 is charged with (V_{OUT}−V_{IN}).

At the time t₀, the state changes to the ON state φ_{ON}. When the switch SW1 is turned off in response to the start signal START_B, charging of the first capacitor C11 is started, and the capacitor voltage V_{C11} rises with a slope proportional to the output voltage V_{OUT}.

Since a potential difference of the second capacitor C12 is maintained during the ON state φ_{ON}, the threshold voltage V_{TH} is calculated as follows.

$${V}_{TH} = ( {V}_{OUT} - {V}_{IN} ) + {V}_{SW} = ( {V}_{OUT} - {V}_{IN} ) + {R}_{ONI} \cdot {I}_{L} . \qquad ( 8 )$$

Therefore, the ON time T_{ON} generated by the ON time generation circuit 320A is expressed as follows.

T_{ON}=C11/α×{(V_{OUT}−V_{IN})+R_{ON1}·I_{L}}/V_{OUT} (9).

As described above, according to the ON time generation circuit 320A of FIG. 27, the ON time T_{ON} in consideration of a coil current I_{L} (that is, the load current) and an ON resistance Rom of the switching transistor M1 can be generated.

In addition, since a low-pass filter is unnecessary as in Example 2 and Example 3 to be described later, mounting can be performed with a small circuit area.

### Example 2

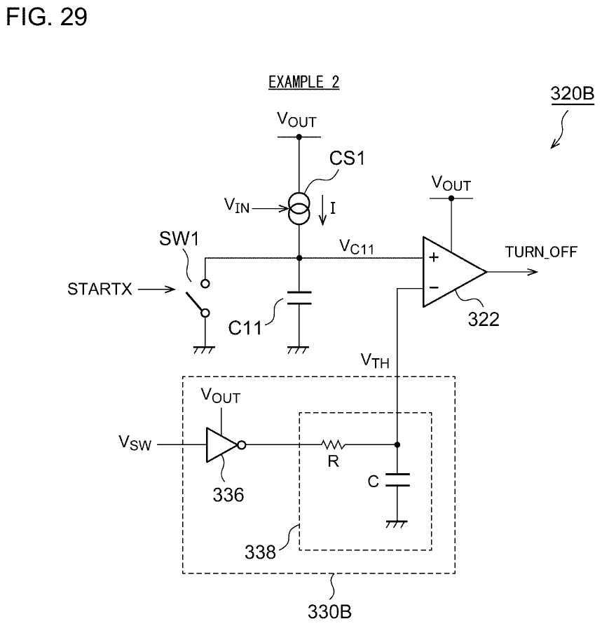

FIG. 29 is a circuit diagram of an ON time generation circuit 320B according to Example 2. The ON time generation circuit 320B is different from the threshold voltage generation circuit 330A of FIG. 27 in the configuration of the threshold voltage generation circuit 330B.

The threshold voltage generation circuit 330B includes an inverter 336 and a low-pass filter 338. The inverter 336 inverts the switching voltage V_{SW} generated in the switching pin SW. The output voltage V_{OUT} is supplied to the power supply terminal of the inverter 336, and thus an amplitude of the output signal of the inverter 336 is equal to the output voltage V_{OUT}.

The low-pass filter 338 smooths the output of the inverter 336 and generates the threshold voltage V_{TH}. For example, the low-pass filter 338 can be configured by an RC filter.

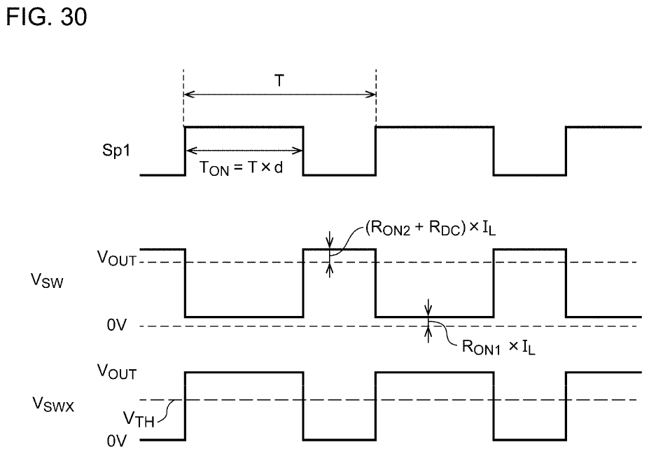

FIG. 30 is an operation waveform diagram of the ON time generation circuit 320B in FIG. 29. The output of the low-pass filter 338 is expressed by Equation (10).

V_{TH}=V_{OUT}×d (10)

d is the duty cycle of the first pulse signal Sp1. Since Equation (4) is established in the steady state of the continuous current mode, Equation (11) is obtained from Equations (4) and (10).

V_{TH}=V_{OUT}×{V_{OUT}−V_{IN}}/V_{OUT}=V_{OUT}−V_{IN}

In other words, the threshold voltage V_{TH} proportional to V_{OUT}−V_{IN} can be generated.

### Example 3

In Example 2, Equation (4) holds during the continuous current mode, but in the discontinuous current mode in which Equation (4) does not hold, the threshold voltage V_{TH} deviates from an appropriate voltage level. Accordingly, a frequency fluctuation rises immediately after the transition from the discontinuous current mode to the continuous current mode. In Example 3, a configuration for solving this problem will be described.

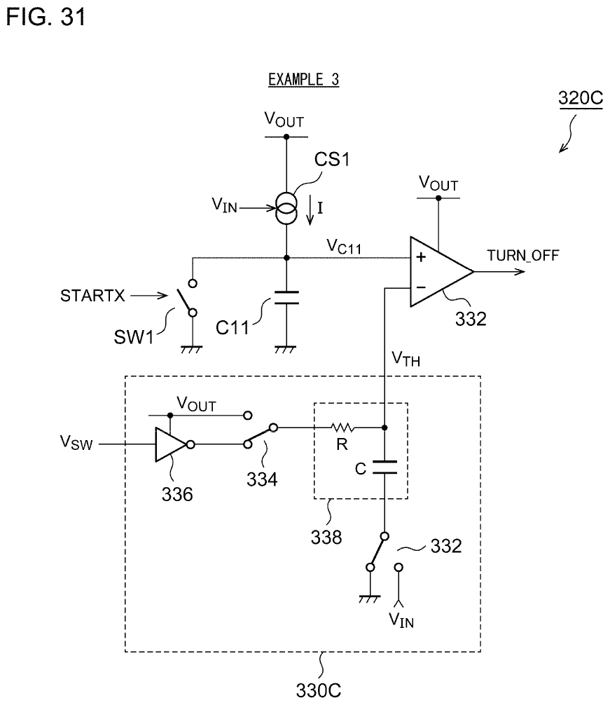

FIG. 31 is a circuit diagram of an ON time generation circuit 320C according to Example 3. A threshold voltage generation circuit 330C is configured to charge a capacitor C of an RC filter 338 with V_{OUT}−V_{IN} while operating in the discontinuous current mode. Specifically, during the discontinuous current mode, V_{OUT} is applied to one end of the capacitor C, and the input voltage V_{IN} is applied to the other end thereof. For example, the threshold voltage generation circuit 330C includes a third selector 340 and a fourth selector 342 in addition to the inverter 336 and the low-pass filter 338.

The third selector 340 applies the output voltage of the inverter 336 to one end of the resistor R during a continuous current mode φ_{CCM}, and applies the output voltage V_{OUT} to one end of the resistor R during a discontinuous current mode φ_{DCM}. Also, the fourth selector 342 applies a ground voltage of 0 V to the other end of the capacitor C during the continuous current mode φ_{CCM} and applies an input voltage V_{IN} to the other end of the capacitor C during the discontinuous current mode φ_{DCM}.

Accordingly, the voltage between both ends of the capacitor C is maintained at V_{OUT}−V_{IN} during the discontinuous current mode φ_{DCM}, so that the operation can be resumed from the appropriate threshold voltage V_{TH} when the mode is transitioned to the continuous current mode φ_{CCM} next.

### Example 4

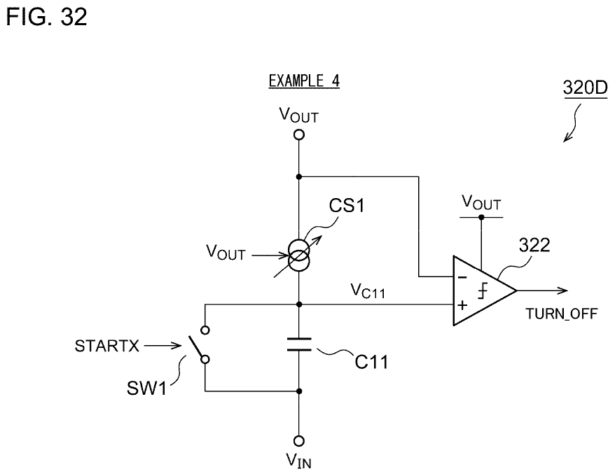

FIG. 32 is a circuit diagram of an ON time generation circuit 320D according to Example 4. The ON time generation circuit 320D includes the comparator 322, the current source CS12, the capacitor C11, and the switch SW1. An input voltage V_{IN} is applied to one end of the capacitor C11.

When the switch SW1 is in the ON state, the capacitor voltage V_{C11} is equal to the input voltage V_{IN}. When the switch SW1 is turned off, the capacitor voltage V_{C11} rises with a slope proportional to the output voltage V_{OUT} with the input voltage V_{IN} as an initial value. The comparator 322 compares the capacitor voltage V_{C11} with the output voltage V_{OUT}. The output TURN_OFF of the comparator 322 transitions in level when the capacitor voltage V_{C11} changes by V_{OUT}−V_{IN}.

In this configuration, since R_{ON} and R_{DC} are ignored, the switching frequency becomes faster in a heavy load state where I_{L} is large, but the switching frequency can be stabilized with a simple configuration.

A modification of the third embodiment will be described.

### Modification 1

In the third embodiment, the switching transistor M1 and the synchronous rectification transistor M2 are integrated in the control circuit 300, but the present invention is not limited thereto, and the switching transistor M1 and the synchronous rectification transistor M2 may be external discrete elements. In addition, the synchronous rectification transistor M2 may be an N-channel MOSFET, and in that case, a bootstrap circuit may be added to the second driver 316.

### Modification 2

Although the boost converter has been described in the third embodiment, the present invention is also applicable to a buck converter and a boost-buck converter.

Although the present invention has been described using specific phrases based on the embodiments, the embodiments merely illustrate the principle and application of the present invention, and many modifications and changes in configuration are recognized in the embodiments without departing from the gist of the present invention defined in the claims.

### Supplementary Note

In the present description, the following technique is mainly disclosed in the third embodiment.

Item 1

A control circuit of a DC/DC converter including a switching transistor, the control circuit comprising:

a current detection circuit structured to generate a first current detection signal indicating a current flowing through the DC/DC converter;

an offset circuit structured to compare a feedback voltage according to an output voltage of the DC/DC converter with a reference voltage, to superimpose an offset signal according to a comparison result on the first current detection signal, and to generate a second current detection signal; and

a main comparator structured to generate a turn-on signal that triggers turn-on of the switching transistor according to a comparison result between a sum of the feedback voltage and the second current detection signal, and the reference voltage.

Item 2

The control circuit according to item 1, wherein the main comparator receives the feedback voltage and the second current detection signal as an input of a first polarity and receives the reference voltage as an input of a second polarity.

Item 3

The control circuit according to item 1 or 2, wherein the offset circuit includes an error detection comparator structured to compare the feedback voltage with the reference voltage, and the offset signal rises or falls according to an output of the error detection comparator.

Item 4

The control circuit according to item 3, wherein the offset circuit further includes a counter structured to generate an offset signal in which a count value rises or falls according to an output of the error detection comparator, and the offset signal corresponds to the count value.

Item 5

The control circuit according to any one of items 1 to 4, wherein

the current detection circuit includes:

a gm amplifier structured to amplify a voltage across a current detection element provided on the current path; and

an impedance circuit structured to convert an output current of the gm amplifier into a voltage signal.

Item 6

The control circuit according to item 5, wherein the offset circuit includes a current source structured to supply a current signal corresponding to the offset signal to the impedance circuit.

Item 7

The control circuit according to any one of items 1 to 6, wherein the first current detection signal and the second current detection signal are differential signals.

Item 8

The control circuit according to any one of items 1 to 6, wherein the first current detection signal is a differential signal, and the second current detection signal is a single-ended signal.

Item 9

The control circuit according to any one of items 1 to 6, wherein the first current detection signal and the second current detection signal are single-ended signals.

Item 10

The control circuit according to item 5 or 6, wherein the offset circuit includes a variable current source structured to be connected to the impedance circuit and whose current amount rises or falls based on a comparison result between the feedback voltage and the reference voltage.

Item 11

The control circuit according to any one of items 1 to 10, wherein the DC/DC converter is of a boost type that boosts an input voltage V_{IN} and generates an output voltage V_{OUT}.

Item 12

The control circuit according to item 11, further comprising:

an ON time generation circuit structured to assert a turn-off signal after an ON time elapses from turn-on of the switching transistor; and

a logic circuit structured to generate a pulse signal that transitions to an ON level when the turn-on signal is asserted and transitions to an OFF level when the turn-off signal is asserted,

wherein the ON time is proportional to (V_{OUT}−V_{IN})/V_{OUT}.

Item 13

The control circuit according to any one of items 1 to 12, wherein the control circuit is integrally integrated on one semiconductor substrate.

Item 14

A power supply circuit comprising:

a main circuit of a DC/DC converter; and

the control circuit according to any one of items 1 to 13.

Item 15

A control method for a DC/DC converter including a switching transistor, the method comprising:

generating a first current detection signal indicating a current flowing through the DC/DC converter;

superimposing, on the first current detection signal, an offset signal based on a comparison result between a feedback voltage corresponding to an output voltage of the DC/DC converter and a reference voltage;

comparing the feedback voltage, the reference voltage, and a second current detection signal after the offset signal is superimposed, and generating a turn-on signal indicating the comparison result;

asserting a turn-off signal after an ON time has elapsed from turn-on of the switching transistor;

generating a pulse signal that transitions to an ON level when the turn-on signal is asserted and transitions to an OFF level when the turn-off signal is asserted; and

driving the switching transistor in response to the pulse signal.

What is claimed is:

1. A control circuit of a DC/DC converter including a switching transistor, the control circuit comprising:
a first voltage dividing circuit structured to divide an output voltage of the DC/DC converter to generate a first feedback voltage;
a second voltage dividing circuit structured to divide the output voltage of the DC/DC converter to generate a second feedback voltage;
a first comparator structured to be enabled during a period in which a wake-up signal is asserted and to assert a first detection signal indicative of a comparison result between the first feedback voltage and a first threshold voltage;
a second comparator structured to be always enabled and to assert a second detection signal indicative of a comparison result between the second feedback voltage and a second threshold voltage;
a logic circuit structured to generate a first pulse signal whose level transitions when the first detection signal or the second detection signal is asserted, to assert the wake-up signal in a non-light load state, and to negate the wake-up signal in a light load state; and
a first driver structured to drive the switching transistor in accordance with the first pulse signal.

2. The control circuit according to claim 1, further comprising
a current zero crossing detection circuit structured to detect a current zero crossing of an inductor of the DC/DC converter,
wherein the logic circuit is structured to assert the wake-up signal after a lapse of a predetermined time from detection of the current zero crossing, and to negate the wake-up signal in response to next assertion of the second detection signal.

3. The control circuit according to claim 2, wherein the current zero crossing detection circuit includes a zero crossing comparator that is disabled during a period in which the wake-up signal is negated.

4. The control circuit according to claim 2, further comprising a second driver structured to drive a synchronous rectification transistor based on a second pulse signal, wherein
the DC/DC converter is of a synchronous rectification type including the synchronous rectification transistor, and
the logic circuit is structured to generate the second pulse signal that transitions to an ON level when the first pulse signal transitions to an OFF level, and transitions to the OFF level when the current zero crossing occurs.

5. The control circuit according to claim 1, wherein the first voltage dividing circuit includes a switch structured to be turned on during a period in which the wake-up signal is asserted.

6. The control circuit according to claim 5, wherein the switch is inserted into a ground side of the first voltage dividing circuit.

7. The control circuit according to claim 1, wherein a resistance constituting the second voltage dividing circuit is larger than a resistance constituting the first voltage dividing circuit.

8. The control circuit according to claim 1, wherein
the second comparator includes:
an enhancement type first NMOS transistor;
a depression type second NMOS transistor whose gate is grounded;
a resistor provided between a source of the first NMOS transistor as well as a source of the second NMOS transistor and a ground; and
a load circuit connected to a drain of the first NMOS transistor and a drain of the second NMOS transistor.

9. The control circuit according to claim 8, wherein the load circuit is a current mirror circuit.

10. The control circuit according to claim 1, wherein the control circuit is integrally integrated on one semiconductor substrate.

11. The control circuit according to claim 1, wherein the DC/DC converter is a boost converter.

12. A power supply circuit comprising:
an output circuit of a DC/DC converter; and
the control circuit according to claim 1.
